(19) United States
(12) Patent Application Publication
(10) Pub. No.: US 2005/0086112 A1
(43) Pub. Date: Apr. 21, 2005

(54) Super-saturation method for information-media

(76) Inventor: Roy Shkedi, New York, NY (US)

Correspondence Address: JOHN ALEXANDER GALBREATH, 2516 CHESTNUT WOODS CT, REISTERSTOWN, MD, 21136, US

(21) Appl. No.: 10/969,288

(22) Filed: Oct. 20, 2004

Related U.S. Application Data
(63) Continuation-in-part of application No. 09/723,391, filed on Nov. 28, 2000, now Pat. No. 6,832,207.

(51) Int. Cl. G06F 17/60

(52) U.S. Cl. 705/14

(57) ABSTRACT

A super-saturation method for information-media, the method including the steps of: (A) facilitating visitor identification and visitor-file supervision by an agency; (B) tagging a preponderance of visitors to a first information-media—wherein said tag corresponds to at least one visitor relevant data-aspects therein; (C) recognizing a visitor to the second information-media as having a tag; (D) accepting an offsite content presentation for the recognized visitor and the content is relevant to at least one data-aspect of the respective visitor-file tag; and (E) presenting the offsite content to the recognized visitor.

### CROSS-REFERENCE TO RELATED APPLICATIONS

This application is a continuation-in-part (“CIP”) of application Ser. No. 09/723,391, entitled A Super-Saturation Method for Information-Media. The disclosures of said application and its entire file wrapper (included all prior art references cited therewith) are hereby specifically incorporated herein by reference in their entirety as if set forth fully herein. Furthermore, a portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to an improved profile data-support method, especially useful for distributing information-media contents. More specifically, the present invention relates to the generation of a new revenue stream to a broadcaster by expanding the information capacity of the media based on the observed behavior of the user.

### BACKGROUND OF THE INVENTION

A super-saturation method for information-media substantially relates to a three-body cooperation to direct information to an electronic media consumer (reader, surfer, viewer, listener, etc.). Embodiments of the original super-saturation invention facilitate a first media body substantially offering out of context information placement using a second cooperating media body. A facilitator body preferably guarantees that a consumer of the second media is a known consumer of the first media. Accordingly, the second media body presents an out of context information placement. For example, an exclusive members-only Internet site “AAA” is oversubscribed with potential paying advertising content at $100 CPM. This exclusive site then offers unfulfilled advertisers an option to present their advertisements to certified “AAA” viewers, albeit on a non-AAA Internet site, for $50 CPM. The facilitator locates a certified AAA viewer at an Internet site “BBB” that normally charges $30 CPM. A facilitated contract(s) between AAA, BBB, and the facilitator divides a new revenue stream of $20 CPM between them—and each of the three bodies benefit. For practical embodiments, a customer CMP sells over 50% of its inventory for $75 and $100 CPM while the big portals, where 80% of the web traffic goes through, don't sell 90% of their inventory and sell for as low as $1 CPM. So, simply stated, the economic reason for super-saturation is arbitrage; the selling site needs to not reduce its rate card for one advertiser—and that a sold out site is only one special case where super-saturation is applicable. The CMP does not need to sell 100% of its site in order to start selling its audience in less salable sections of CMP for a discounted price or on other sites for a significantly discounted price. Moreover, in real life, it is not common to find a sold out site. In fact, only a tiny minority of all sites are highly subscribed or over subscribed with third-party paid-for content, advertising, or the likes.

Alternately stated, the original super-saturation invention facilitates identification of a party known to partake in information at some media site when that party is discovered at another media site. For example, a frequent visitor to the web-site of the exclusive “Business Week” is found browsing at the web-site of the open chat line of the “Page-Six (the gossip section of the New York Post).” While correctly configuring a new revenue stream, the original super-saturation invention nevertheless apparently relied on historic media industry assumptions about the profile of a visitor. These industry assumptions, in the example, partially relate to market studies done on the respective print media of the Business Week and the Page-Six. However, today, studies are conducted on the composition of the web sites audiences as well. For example, were it the case that respective subscriptions to the print media cost twenty five dollars per issue and twenty five cents per issue, then one could easily guess that the average family income of the Business Week reader would be far higher than that of the Page-Six reader. However, it is often the case that the web-site readers reflect different constituencies than the corresponding print media. Thus it would be desirable for niche site section visitors to be found elsewhere wherever that would be. The only thing that matters is finding them on places where the arbitrage of “content presentation” will make it economic viable. The odds of finding expensive audience viewing cheap media are higher on highly trafficked sites such as Yahoo or the New York Post, etc. For example, there may be many Business Week purchasers who exhibit the printed version on their desk or in their office, because the associated price makes exhibition an easily recognizable status symbol. It is not necessarily correct to presume that the correlation for the profile of the print purchaser is substantially equivalent for the web-site viewer. 80% of the traffic is within the portals (e.g. AOL or Yahoo).

Of course the metric CPM is an industry standard based on thousands of clicks, visitations, or observations—but all CPM relevant technologies (e.g. the instant and prior super saturation for information-media methods) are accomplished at each click, visitation, observation, etc. From a publisher perspective at the end of the day it doesn't matter whether the advertisers pay per click or for every viewed ad, the publisher converts all payments he receives whether from clicks or for every viewed ad into Effective CPM which is the effective price the publisher received for every thousand ads it allocated to a certain entity. Makes sense, since the publisher's asset is its ad space and it is looking to maximize its return from it and by converting all payments into ECPM it can compare apples to apples—how much did they receive for every 1,000 ads regardless of the payment method (pay per click, pay per view, pay per lead, pay per acquisition etc).

Returning now to the original super-saturation invention, there was (and is) a benefit in the advertising industry to identifying a Business Week web-site viewer when he was visiting the Page-Six web-site, because the “facilitator body” of the original super-saturation invention can place advertisement content (e.g. banners or any other kind of ad) on the viewed Page-Six page and charge a CPM rate that is more typical of the high priced Business Week than the low cost Page-Six. Furthermore, the facilitator may divide royalty portions of the CPM improvement between the Business Week and the Page-Six—thereby creating a new revenue stream for all of the three parties while at the same time providing the ad viewer with relevant ads in a privacy friendly manner. The beauty of the super saturation is that the high CPM site makes the sale to the advertisers that are used to buy their audience from them for decades, just to receive that audience wherever they are—thanks to the facilitator. The low CPM site receives an ‘access fee’ which is a flat CPM or % of revenues and the facilitator receives 15% of the generated revenues.

The brand advertisers need to make large scale media buys that will enable them to reach their target audience in an effective and simple way. Reach InformationWeek lucrative audience wherever they are for a differentiated price—$100 CPM within the site and $40 on other sites. Paid search advertisers that don't buy in advance but bid for every clicked ad of theirs want as much traffic as they place can their hands on as long as the ROI metrics work on their behalf. If they pay $3 per click of someone that searched for ‘Health Insurance’ and they are able to covert 1 person out of 10 people that click their ads then their customer acquisition cost is $30. As long as the $30 customer acquisition cost is less than their profit from the product it is worth while for them to get as many people as possible clicking their ad especially since they don't need to buy in advance or do anything different besides allocating more budget to their bidding budget.

What's especially unique in the variants of the instant invention is showing ads (or related content) to people within the same site based on their observed interests and more importantly among sites—one site sells its own advertisers ads to its own audience based on their visit to the site, what they searched on the site, or the profile they provided to the site. The site sells access to the audience when they are on other sites (not in the same site) in return for paying other sites ‘access fee’ for access to its audience through their ad space. Alternatively, an Agency can sell to the advertisers based on the audience profiles on site 1 when they are found on site 2 and compensate site 1 & site 2.

In summary, for the advertising media engaged in targeted information-media, an electronic visitor is a commodity representing potential revenue, if properly exploited. The need in the industry is to improve understanding of the visitor, so that the opportunity of his visit can be more lucrative. Existing generally accepted profiling methods strongly rely on demographic presumptions, even if improved by a facilitator's memory of a specific visitor's transient viewing of known media content—such as the Business Week or the Page-Six.

Electronic advertisement placement service bureaus exploit specific advertisement opportunities using known profile elements of the visitor, These elements are collections of marginal self-disclosure data, occasional visiting events, and gross aggregate interpretations of what kind of a mercantile opportunity such a profiled visitor represents. What would help the quality of profiling and profiling interpretations is to know what the visitor personally thinks about.

In conclusion, the simple way to describe the industry need is to say that there is a need to allow the visitor to disclose his thoughts and interests so that the facilitator will be better prepared to present the visitor with information content (e.g. advertisements) that are particularly relevant to the visitors profile—as best understood when interpreted in conjunction with personal aspects of the visitor's thoughts. Clearly, fulfilling this industry need should be tempered with respect for the anonymity of the visitor; and other moral, ethical, and legal considerations.

Finally, it is worthy to note that substantially the same expectations of economic benefits for improved profile data, that characterize today's internet advertising milieu, are to be found in telecommunications advertising, in internet non-advertising information transfer, and in other aspects of telecommunications information-media transfer. Therefore, it may be appropriate to observe that the longstanding needs of the Internet for improved profiling are likewise characteristic of other telecommunications systems; and that a constant need for progress in these areas remains.

Notices

Numbers, alphabetic characters, and roman symbols are designated herein for convenience of explanations only, and should by no means be regarded as imposing particular order on any method steps. Likewise, the present invention will herein be described with a certain degree of particularity, however those versed in the art will readily appreciate that various modifications and alterations may be carried out without departing from either the spirit or scope, as hereinafter claimed.

In describing the present invention, explanations are presented in light of currently accepted data communications theories and media models. Such theories and models are subject to changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching, the current man of the art or the current team of the art, how these embodiments may be substantially realized in practice. Alternative or equivalent explanations for these embodiments may neither deny nor alter their realization.

Furthermore, in most instances in the context of the present invention, an example of a facilitation is an offer; in other instances, a facilitation may be appreciated to include performance of an activity or an acceptance—as will forthwith be further appreciated by examples provided in the following Glossary.

However, it if first necessary to emphasize that uniqueness of the instant invention (as noted in the Background Section) is in one site selling access to its audience on another site, one media selling access to its audience at another media, and the likes.

Glossary

Broadcaster: A broadcaster is a participant in a distribution of electronic signals—be they digital signals, analog signals, or the likes. For example, in the context of the Internet, a broadcaster is preferably a media owner. In the broad context of interactive bidirectional electronic communications, a broadcaster is a predetermined party in a transmission path from a present communications initiator to a present designated recipient—for example a telephone call initiator, any repeater in the interconnection of that call to the recipient, or the recipient. Furthermore, in the context of today's hybrid electronic media, a broadcaster may be a programmable component that can be inserted into the caller to recipient path.

In the context of broadcaster, Peer-to peer (P2P) platform is a subsidy to the content downloaded through the P2P platform by showing a user ads that are relevant to him on other publisher sites (the P2P is the first broadcaster). The ads being relevant to either the media downloaded by the user or to products or services the user stated that he will be interested in. Alternatively, the P2P platform could be used as the second broadcaster where ads will be shown to the user based on his profile on other sites that will act as the first broadcaster.

Broadcaster 1—for example—is a Search engine, Paid Search ads provider, Adware companies, any high CPM web site, any site, P2P platform. Many of the Paid Search providers distribute their ads via XML and only when the user click their ads do they know of it. Nevertheless, the Paid Search provider's ad content is part of the search result page viewed by the user and therefore the Paid Search provider is considered a first Broadcaster that learns of the interest in his content when a user clicks the ad. It should be emphasized that the Paid Search provider, like any web site that sells media, represent many advertisers to whom it sells media and that it is not obligated to any of its advertisers to show their ad again to someone that clicked their ad on a search results page when a second ad is presented to that person within the ad space of a second Broadcaster. Adware companies provide free software providers with a way to monetize their software by bundling the adware downloadable software with the free software downloaded by the user. The adware software either present ads to the user when he uses the downloadable application or/and present the user with ads (such as pop-up ads or pop-under ads) based on his observed behavior on the internet wherever he is. For example, a user with an adware software installed on his computer that will visit the travel site Travelocity could be presented with a pop-up ad from Expedia that will be served to him by the adware company. The adware companies value to their software users are questioned by many of the users that are not happy among other things with the additional ads that they are presented with by the adware software. The adware companies could utilize ‘Super Saturation’ by tracking their software users behavior but not exposing them to additional ads. Instead the Adware company could act as the first broadcaster and sell its advertisers ads that will be presented to its Adware software users within the ad space of a Broadcaster 2 where the Adware company will buy media in order to reach its users when visiting Broadcaster 2. This way the users will not be exposed to additional ads, just have the ads they are exposed to anyhow when visiting Broadcaster 2 relevant to them. Alternatively, the Adware company acting as Broadcaster 1 could have an agency sell advertisers ads to the adware software users based on their behavior on the web as observed by the adware company and the ads will be presented to the users when they are visiting Broadcaster 2 where the agency will buy media. Broadcaster 2—for example—is any web site where the first broadcaster audience can be found and be presented with ads based on their profile with the first broadcaster. Also, adware companies that do not track their users such as Weatherbug or P2P platforms could act as Broadcaster 2.

Conjunction: In the context of the present invention, the expression “in conjunction” relates to a division of work between parties, such as between an agency and a broadcaster. This division may be of any proportion—so long as a nominal task remains for one of the parties to accomplish. In some circumstances, there is a definite preference for the division of labor to have a specific predefined asymmetry, while in other circumstances the division may occur using a simple easy to accomplish criteria. Furthermore, sometimes there is a specific bias as to which party performs some specific aspect of the conjunctive task, for example, according to a concern to preserve privacy, etc.

Cookie: A Cookie is a message given to a Web browser by a Web server. The browser stores the message in a text file called cookie.txt or a cookie directory or the likes. The message is then sent back to the server each time the browser requests a page from the server. Cookies serve as recognition symbols or messages in a particular Web browser that can be recognized and acted upon by that cookie placing Web server. Web environments substantially provide information services. However in the context of the present invention, for commodities and durable goods —an RFID tag is substantially a cookie too.

Offsite Content: In the context of the present invention, offsite content is content that derived from outside of the immediate local context of a present site. For example, on an Internet page, an offsite content may be a banner ad relevant to a recent search conducted by the page viewer or a banner ad relevant to a recently visited high CPM site. As noted the banner ad is relevant to a recent visit of the page viewer to another site or section of a site and had nothing to do with the content of the present page. In the context of a telephone conversation between two parties, an audio time pulse placed by the telephone service provider is also an example of an offsite content. Likewise, “piped in” background music that a caller hears when waiting for his call to be transferred is an example of an offsite content.

Super-saturation: In the context of the present invention, the term Saturation simplistically describes a situation where a data communication media site contains a maximum predetermined amount of content presentation apart from core information. This content presentation may be in the form of advertisements, notifications and other information not directly associated with core data. Maximum amount of content presentation is limited by physical, aesthetic and pragmatic factors. Exceeding this saturation level leads to the state of out of context media fulfillment, that is, containing more content presentation than is desirable, pragmatic, physically possible or aesthetically pleasing.

Alternatively, in the context of the present invention, a more pragmatic definition for the term Saturation relates to a current level of predetermined content in a specific media instance; for example a web site currently has sold 20% of the space that it has allocated for advertising. In the nomenclature of the present invention, this represents a level of actual saturation of 20% of available in context advertising potential. The present invention generally relates to a super-saturation method whereby a new revenue stream is created by facilitating out of context potential (for advertising or otherwise) that is in excess of any actual saturation—be it 20% as in the pragmatic example or be it 100% as in the prior simplistic example.

Simply stated, super-saturation relates to facilitating out of context placement of content, and this placement is by definition in addition to the saturation of the in context material—regardless of the level of in context materials.

SIM Card: This is a Subscriber Identity Module card that is commonly inserted into a cellular telephone. In the context of the instant invention, the SIM is substantially a functionally identical albeit different embodiment form a cookie or an RFID tag.

Tagging: Tagging relates to an identification that reveals that the tagged visitor is known to have been at a predetermined information-media, such as an internet site or a specific internet page, or have dialed up to a specific telephone number, etc. The tag need not contain any information that identifies the visitor nor need it contain any information that allows the visitor to be profiled. A tag simply identifies that its physical or logical bearer was so marked for having been at a specific location, or for having been there for a predetermined amount of time, or for having conducted some specific action there, etc. For practical purposes, sampling of the top bids for each phrase the person searched for at the time of the tagging in order to be able to later when the time comes to decide in real-time which ad to serve to a person that searched for multiple phrases—without the need to check in real-time what are the top bids for every phrase the person searched for. Basically —if we had to check at the point where the ad needs to be served to the person what are the top bids for each phrase the person recently searched for at each of the partner paid search provider, then the odds are that the ad or content would not have been presented to the user within a reasonable time frame. Obviously there is an underlying assumption here that the top bids for a certain phrase will not materially change between the time the search was conducted to the time the person would be found later on another publisher site and an ad would be served to him that will be relevant to recent searches made by him.

In order to fully appreciate the scope of the instant invention, it is necessary to appreciate the variations and substantial equivalents of tags and “tagging”. Since principal embodiments of the instant invention substantially reside in a distributed computer environment, it makes some sense to take a moment to understand that environment and the features that the ordinary man of the art considers equivalent there; and from that vantage it will be easy to understanding these tags”.

There is a well-established consideration in the art that software may be bi-directionally transformed into (or from) electronic hardware. That means that, just like in patents, that there are many equivalent ways to embody a software functional specification; and for each software embodiment there is at least one equivalent hardware embodiment. Furthermore, within the domain of software design there is a well-known equivalency between physical and logical addresses—thereby allowing general purpose “software or hardware computing machines” to emulate special purpose specifications and even to allow special purpose “machines” to emulate general purpose specifications.

Now, with the advent of countless data communications protocols, logical and physical address have taken on global proportions—to the extent that the Internet is in some sense a single very distributed “machine”. Furthermore, in the context of intra computing “machine” protocols there have simultaneously arisen uncountable embedded systems within and across these distributed “machine” architectures. Thus, at a higher scale, the merging of physical and logical implementations has grown to become a merging of real and virtual implementations.

Returning now to our concern with appreciating the full scope of tags and tagging in the context of the instant invention, firstly one must recognize that tags are according to a class of visitors.

If the visitor is a physical device passing a physical sensor then the tag can be an RFID tag and the tagging may be by writing to the memory of RFID tag or by noting a hardwired ID of the tag into a database in communications with the sensor; or even considering the signatures of a collection of tags of the physical device as collectively identifying that device. For example, a person having RFID tags in his shoes, credit cards, and cell-phone is considered to be tagged simply by the correlation of product codes—even if that correlation may be true of another person. In this example, a Nike shoe product tag plus a master-charge card class identifier plus a Nokia phone product tag is enough to use to study the visitations and time spent by this person in a shopping center enabled with sufficient numbers of sensors.

Alternatively, if the visitor is a logical device such as an internet surfer, then the tag may be a “physical” (string of software-date signature) cookie set (by remote data communications) in the surfer's machine or the tag may be a “virtual” observation relating to the correlation of items such as EP address and time of day—essentially like the RFID correlation tag.

Now returning to the issue of tags and their equivalence, it is reasonable the tag will be physical or virtual, singular or a correlation of observations—all in accordance to the nature of the broadcasters; and on occasion in consideration of the media of the content to be presented to the visitor too. In summary, a tag could be a cookie or an RFID or a SIM card or a fixed ‘P address (in case of either a cable modem where the HP address usually doesn't change unless the user reboot its modem or just a user that chose to have a fixed IP) or it could be any kind of tag or combination of tags that enable the unique identification of the user it self or the machine/device it is using to access media. The tagging may take place when the user watch a page or click a part of the page (such as an ad) therefore indicating his interest in the provided content or when the user passes a detector or when the user makes a telephone call, etc. It should be emphasized that the goal of the tagging is to have the ability to recognize in the future a user that visited a page or a section or site or any other media outlet. In other words any mean that could facilitate the recognition of that user or the machine/device used by the user (to access the media outlet) could set as a Tag. This Tag could be also be accomplished by using the ID of the machine used by the user as the anchor of the user's profile in a database. The machine ID could be a cookie, an IP address, a cell phone number, a set top box ID etc.

### SUMMARY OF THE INVENTION

According to the core-technology embodiment of the super-saturation method for information-media of the present invention, whereby a second information-media broadcaster in conjunction with an agency extends a content presentation of a first broadcaster beyond a predetermined information-media saturation threshold for content presentation of the first broadcaster, the instant invention method is including the steps of: (A) facilitating (an agreement between the first broadcaster and second broadcaster allowing) visitor identification and visitor-file (e.g. an entry in a database, data in a cookie, data in an RFID tag, data in a SIM card, or the likes) supervision by an agency; (B) tagging, by a first broadcaster of a first information-media in conjunction with the agency, a preponderance of visitors to the first information-media with a tag—wherein said tag corresponds to an agency supervised visitor-file and the respective visitor-file has at least one visitor relevant data-aspects therein; (C) recognizing, by a second broadcaster of a second information-media in conjunction with the agency, a visitor to the second information-media as having a tag—wherein said tag corresponds to the agency supervised visitor-file; (D) accepting, by the second broadcaster in conjunction with either the agency or the first broadcaster, an offsite content presentation for the recognized visitor and the content is relevant to at least one data-aspect of the respective visitor-file; and (E) presenting the offsite content to the recognized visitor.

Furthermore, according to the preferred core-technology embodiment variation of the super-saturation method for information-media of the present invention, at least one of the visitor relevant data-aspects are preferably selected from the list: visitor provided profile disclosure, word or phrase searched by the visitor as observed by the first broadcaster in conjunction with the agency, visitor provided search word, visitor provided search phrase, product or service the visitor is interested in as observed by the first broadcaster in conjunction with the agency, visitor provided product or service he is interested in, visitor provided search cluster string, visitor provided image, visitor provided image fragment, visitor provided bio-metric, characterization of content at the first information-media, characterization of content at a second information-media where-at offsite content was presented using the super-saturation method, and the likes.

Data-aspects may relate to any of the profile attributes in the supervised visitor-file including the phrase the visitor searched for, the content the visitor read, content the visitor clicked on, a product or service the visitor was interested in, etc. It should be noted that in cases where the agency works with several first broadcasters that the profile attribute provided by the first broadcaster is recorded along with the first broadcaster ID in order for the agency to later be able to link the revenues from the specific profile attribute based ad with the correct first broadcaster. This info provider site (i.e. the broadcaster) will later be compensated with royalties for the information that will enable showing that person additional ads or contents that are relevant to the search he conducted on site 1 when he will be found on a different site (site 2). Example of one way to choose which profile attributes will be used for serving an ad to the user, the optimization process which is aimed at maximizing the ECPM of the ad space where the ad will be presented within. The pulling of the selected paid search listings that will be integrated into the ad either from the paid search provider in real-time or from the cache if the paid search provider gave the permission to use an hour old ads for example (or 7 days old, etc.). The presentation of the listings within an ad that grabs the user's attention by placing the listings next to a question addressed to the ad viewer whether he searched for the phrase he searched for.

Certainly, there should be an option to the user within the ad to opt-out from receiving future targeted ads. The opt-out may be achieved through the placement of a cookie in the respective visitor-file. The opt-out may be offered directly within the ad or there will be a link to the agency that if a user will click will take him to a page from which he could opt-out if he wants to.

The present invention also relates to embodiments of a pro-active profile method. The instant method is especially useful in conjunction with the super-saturation of information-media of the instant invention. According to this instant method variation the facilitating step includes the steps of: a pro-active supervisor program operating in a data-communications network environment (A) validating an identifier at a computer-communications machine in a data-communications network; (B) maintaining an attribute profile corresponding to the identifier; (C) for substantially each occurrence of the validating wherein the machine is transmitting a parameter string, incorporating at least one attribute of that string into the profile; and (D) for substantially each occurrence of the validating wherein the machine is in the process of receiving information-media content having at least one slot for elective content, consulting the profile in order to select a preferred instance of information-media for the at least one slot. However, in the case of the adware company relevant variant embodiments of the instant invention, the adware “agency” will use the gathered profile to sell its advertisers ads to its users when they are on other sites in order not to saturate the user with pop-ups that are in addition to the ads he is already exposed to on the sites he is visiting. The simplest instance of an example of the instant invention relates to a scenario whereby an internet user transmits search strings to a search engine and later, while surfing the net, will receive banners that relate to attributes of the keywords in those search strings. In this simplest example, validating means recognizing a cookie, and consulting means using the knowledge of these specific key words as part of the criteria in a banner selection operation. In the real world, certain key words are associated with more lucrative advertisement banners while others are associated with more mundane blocks of informational content. Thus, there are special embodiments of the present invention that allow a user to pay a subscription to receive relevant and timely content rather than allowing advertising market factors to determine banners selected for his viewing, or the likes (see example below about credit notices, personal notices and the likes). More specifically, these special embodiments consider combinatorial sets of recent search terms and their synonyms in activating personal agents to explore deep data warehouses and return the focused findings. Properly appreciated, the instant invention facilitates numerous opportunities for appreciating search engine results that do not arrive in real time. More particularly, these results may not be from the original search engine, but from a coordinated effort of producers, advertisers, and advertisement agencies. Stated differently, just like the broadcasters presume that a visitor remains consistently interested in activities relevant to his profiled prior activities, so too the visitor is interested in continuing to receive information relevant to the continuation of those activities—so there is an opportunity for the visitor to subscribe to personalized super-saturation styled content even if the subsequent broadcaster(s) are not participants.

In the context of the instant invention, a data-communications network environment is a dependent term that relates to an infrastructure established to electronically transfer predetermined information-media contents. In today's rapidly converging technology, even the names for these “networks” are undergoing continual revision. Nevertheless, according to the following examples, the man of the art will readily recognize both familiar and evolving “environments”. One group of examples of a data-communications network environment is the Internet, extra-nets, LANs, WANs, and the likes; all of which are substantially used to transfer information-media including URLs, banners, voice-over-IP, audio files, graphic files, audio-visual files, electronic mail, and the likes. Another group of examples of a data-communications network environment is the terrestrial telephone system including at least one system selected from the list: legacy systems, cellular wireless systems, cable media systems, and the likes; all of which are used to transfer information-media as in the first example group, and/or voice, television, radio, security codes, short messages, and the likes. Therefore, the relevant computer-communications “machine” may be a personal computer, a Personal Data Assistant, a cellular telephone, a telephone-terminal, or the likes.

Now, the instant invention provides an improved facility to use profile attributes to select information-media content (e.g. an advertising banner) for presentation to a computer-communications machine (e.g. a personal computer surfing the Internet) associated with the profile. For example, if the profile includes recent search terms used by the machine during query of a search engine, then the consulting step will contribute to a recommendation for banners that are associated with these terms or with synonyms thereof. On the one hand, it should be appreciated that the consultation of the instant invention is not necessarily the dominant factor in selecting an instance of media-content. Specifically, other factors, such as recently visited URLs or data contributed to the profile by the operator of the respective computer-communications machine, may predominate for any specific instance. On the other hand, the search terms enable the profile with a deeper appreciation of the operator's thought processes, such that the banners selected in consultation with the instant invention may be considered as personally relevant, albeit perhaps late, background results to searches executed by the operator.

Returning to the broad definition of the principle embodiments of the instant invention, the instant method includes steps involving activity by a pro-active supervisor program operating in a data-communications network environment. Substantially the supervisor program, be it centralized or distributed, is functioning as a proactive intermediary in the environment where copies of information-media content are being electronically transferred.

Firstly, the pro-active supervisor program must maintain the integrity of its application, and this is accomplished in the step of: (A) validating an identifier at a computer-communications machine in a data-communications network—during a plurality of parameter transferring activities and during at least one information-media content placement event. Presumptively, for the first occurrence of this step there may be a need for registration and/or cookie placement, and/or tagging etc.; or such registration and/or cookie placement may be facilitated elsewhere by a cooperating body—such as an advertising agency that receives the “consultation” with the instant invention program For practical purposes, publishers are cooperating bodies if they provide the service to advertising agency (as in step D—below).

Secondly, the pro-active supervisor program must preserve profile information that may be useful in selecting information-media content appropriate for the operator associated with the machine, and this is accomplished in the step of: (B) maintaining an attribute profile corresponding to the identifier. According to alternative embodiments of the instant invention, the maintaining may be a virtual management function where by the actual physical “maintaining” may be performed by an external agency. Thus the instant step of “maintaining” may be transaction-initiated by the program—while the physical maintaining may be located substantially anywhere in the data-communications environment.

Thirdly, the pro-active supervisor program is specifically facile in anticipation of future need (step D—below) by considering parameters of a transaction string as relevant to profile improvement, and this is accomplished in the step of: (C) for substantially each occurrence of the validating wherein the machine is transmitting a parameter string, incorporating at least one attribute of that string into the profile.

Finally, the pro-active supervisor program is appreciated as being able to fulfill its proactive mandate for improved profile application, and this is accomplished in the step of: (D) for substantially each occurrence of the validating wherein the machine is in the process of receiving information-media content having at least one slot for elective content, consulting the profile in order to select a preferred instance of information-media for the at least one slot. For simplicity, a slot may be a Search Result Placement, banner area in a URL of the Internet, an SMS in a cellular telephone communications event, a custom tailored email having accumulated profile relevant content that has been located since the last request for custom tailored email, or the likes. The step of “consulting” is performed according to multi-parametric factors of a specific instance: such as highest CPM in banners, etc. Note that the four aforementioned steps are independently necessary elements for facilitation of instantiations of the instant invention. Nevertheless, it is unlikely that there are occurrences of a sequential operation of the steps. Rather, each step performed as needed will contribute to the infrastructure of the instant method—and allow the desired improvement to result.

The instant invention applications are extensions of the super saturation where advertisers bid for placing their message on a search result page to a visitor that searched in the last X days for a keyword that they believe indicate the person's potential interest in their product. The advertisers ‘out of context’ messages that are chosen to be presented to the visitor are those that their advertisers are willing to pay the highest price per click. (It should be clear that the Super Saturation Method already includes the presentation of an ‘out of context’ message to someone that searched for a keyword.)

According to the various embodiments of the instant invention, the step of validating includes recognizing a cookie as the identifier; a caller-ID as the identifier; an RFID as the identifier; or the likes. In most data-communications environments, the validating step need not breach the privacy of anonymity of the machine operator—because you do not need the personal identification details of the person, just to recognize it is the same machine again. According to the preferred embodiment of the instant invention, the step of validating includes registering a profile detail restriction level from the computer-communications machine. This aspect is the key to “freedom of privacy.” On the one hand this freedom allows the user of the machine to elect any reasonable or severe level of profile data collection and profile access. On the other hand the user may prefer to maximally cooperate in building his profile and in allowing profiling of the content he/she views—since the user may elect that he will have maximum benefit if those who are seeking users with his profile can find him and within the ad space which is already present on the pages he views will insert their ads that are relevant to him based on his profile!

According to the various embodiments of the instant invention, the step of maintaining includes accumulating URL visitation data; terms, products, etc. searched for, accumulating commercial transaction data; accumulating caller activity data; or the likes.

According to the preferred embodiment of the instant invention, the step of incorporating includes recording at least one attribute associated with the destination for the transmitting. Specifically, the step of recording preferably includes classifying into a category selected from the list: search engine, commercial query, commercial transaction, media warehouse, chat room, group-ware tool, e-learning seminar, interactive web-cast, matching engine, or the likes.

Furthermore, according to the preferred embodiment of the instant invention, the step of incorporating includes clustering pointers, for use in correlating parameter strings having multiple attributes. For example, it may be pertinent to preserve the order of all words in a single search string and the fact that they were grouped together. Additionally, it may be important for weighting and analysis of the profile, in the “consulting” step, to distinguish between actual key words and synthetically created synonyms.

In addition, according to the preferred embodiment of the instant invention, the step of incorporating includes recording temporal data, and the temporal data is selected from the list: time, exact absolute date, approximate absolute date, exact relative sequential relation to prior recorded temporal dates in the respective profile, and approximate relative sequential relation to prior recorded temporal dates in the respective profile.

Finally, according to the preferred embodiment of the instant invention, the step of consulting includes preprocessing the profile at predetermined times—since often a best real-time response can only be actualized if the profile has been recently processed.

Now, when we consider the narrow application of super-saturation embodiments in the context of search engine protocol engineering, we are also considering embodiments that facilitate Post Search Targeted Advertising involves displaying text-ads, similar to those that are placed within paid-search results. These text-ads can be integrated into any ad space allocated by a publisher. The trigger for displaying any Post Search Targeted ad on a page is recognizing that the publisher's visitor, who is about to view the page, has recently searched either on the site or anywhere across the web. The term or phrase the visitor about to view the page has recently searched for is sent in real-time to the paid search provider. The paid listings the paid search provider returns are integrated into the ad space allocated by the publisher. The Post Search solution decides which of the terms the visitor has searched for recently should the ad be relevant to based on the effective CPM expected to be generated by the term. Obviously, the Post Search solution is looking to maximize the effective CPM. For example, a person searched for Health Insurance on Google (first broadcaster) will find a banner add related to Health Insurance when he visits MSN (second broadcaster); etc.

Here follows a non-limiting sample workflow of the Post Search Server as well as the requested information from the Paid-Search provider:

Search Traffic. A person visits a search engine and searches for a phrase. Profiling. The visitor that searches is redirected to a Post Search server (visitor-file supervision data aspect memory media—centralized or distributed database) along with the phrase he searched for in order to be tagged for future recognition as well as record the ‘Search Traffic provider’ identity. The Search Traffic provider identity is required in order to know to whom should royalties be given when the visitor will later on click on an ad based on the information provided by Search Traffic provider. The Search Traffic provider is the first broadcaster! As Post Search Targeted ads are time sensitive, the visitor tag also includes a time stamp.

Top Bids Query process. The Post Search server checks what are the top bids for the phrase the person searched for. The Post Search server determines the top bids either by querying: A file which is provided and constantly updated by the Paid Search provider OR A database of search phrases and top bids accumulated by the agency from the paid search providers' responses. The information in this database is always no more then 7 days old to make sure that the agency will always have up to date bids OR The Paid Search provider's server in case that the file provided by the Paid Search provider (if provided) and the database accumulated by the agency did not include the exact search phrase the person searched for. Recognition. Later on the person is recognized while visiting a site.

Selection Process. In this process the Post Search server needs to choose, which of the phrases that the visitor about to view the ad has searched for recently should be used as a targeting criteria for the ad. The parameters are taken into account when choosing the phrase in this process—for example:
(1) Recency. The phrase was searched for in the last 7 or 30 days (i.e. for a predetermined time interval or according to a statistical temporal metric).
(2) Frequency cap. The phrase cannot participate in the process if it was used as a targeting criteria for an ad for this visitor in the last hour OR more than 3 times in the last 24 hours OR the person clicked more then 3 times on ads relevant to this phrase within the last 72 hours.
(3) Rotation. During the initial ramp-up period ads that will be based on the phrases with the top bids will be rotated in order to maximize click-through and revenues. Rotation of the top 5-10 phrases in terms of bids is currently planned. After the initial ramp-up phase, as more statistical information will be accumulated such as how the click-through on a phrase fluctuates as a function of how long ago the search was made and how a click-through on a phrase changes as a function of the site the phrase is presented on, those additional parameters will be taken into account when deciding which ads to include in the rotation. The ads chosen to participate in the rotation are always those expected to generate the highest effective CPM based on all available information.
(4) Pulling Paid Search Listings. As the visitor is waiting to view an ad, the phrase chosen at the ‘Selection Process’ is communicated in real-time to the Paid Search provider. The Paid Search provider returns to the Post SeUearch seer the top paid listings for the given phrase, the associated links and bids. In case the Post Search server has already received from the Paid Search provider the listings, links and bids for the exact same search phrase in the last 24 hours, then preferably those listings, links and bids could be taken from the cache and the Paid Search provider server will not be contacted therefore saving both the Paid Search provider and the agency an additional query.
(5) Integrating Listings into allocated ad space. The Post Search server integrates the pulled listings into the allocated ad space. The Post Search server may integrate those listings into a rich media ad that will grab the user's attention by specifically asking the user whether he searched for the phrase he searched for and next to the question presenting the user with the listings.

A non-limiting example for a suggested structure for a ‘Top Bids Query’ file (XML):

```
<PSP_Data  PSP_Id=1345>
<Keyword Name=“Health Insurance”>
<Bids>
    <Bid_Price>12</Bid_Price>
    <Bid_Price>10</Bid_Price>
    <Bid_Price>7</Bid_Price>
</Bids>
<Keyword Name=“Travel”>
<Bids>
    <Bid_Price>20</Bid_Price>
</Bids>
<Keyword Name=“Travel Agency”>
<Bids>
    <Bid_Price>20</Bid_Price>
</Bids>
<Keyword Name=“Stock Price”>
<Bids>
    <Bid_Price>22</Bid_Price>
    <Bid_Price>18</Bid_Price>
    <Bid_Price>17</Bid_Price>
    <Bid_Price>15</Bid_Price>
    <Bid_Price>9</Bid_Price>
    <Bid_Price>3</Bid_Price>
</Bids>
<Keyword Name=“Stock Prices”>
<Bids>
    <Bid_Price>22</Bid_Price>
    <Bid_Price>18</Bid_Price>
    <Bid_Price>17</Bid_Price>
    <Bid_Price>15</Bid_Price>
    <Bid_Price>9</Bid_Price>
    <Bid_Price>3</Bid_Price>
</Bids>
</PSP_Data>
```

### BRIEF DESCRIPTION OF THE FIGURES

In order to understand the invention and to see how it may be carried out in practice, embodiments will now be described, by way of non-limiting example only, with reference to the accompanying drawings, in which:

FIG. 1 illustrates a schematic view of a super-saturation method for information-media;

FIG. 2 illustrates a schematic view of a first contractual agreement;

FIG. 3 illustrates a schematic view of a second contractual arrangement;

FIG. 4 illustrates a schematic view relating to a first broadcaster providing a facilitated tagging of a preponderance of visitors to the first information-media;

FIG. 5 illustrates a schematic view relating to an agency 502 providing a facilitated offsite placement of a content deriving from the first contractual agreement, the agency paying the first broadcaster;

FIG. 6 illustrates a schematic view relating to a third contractual agreement; and

FIG. 7 illustrates a schematic view relating to details of the third contractual agreement.

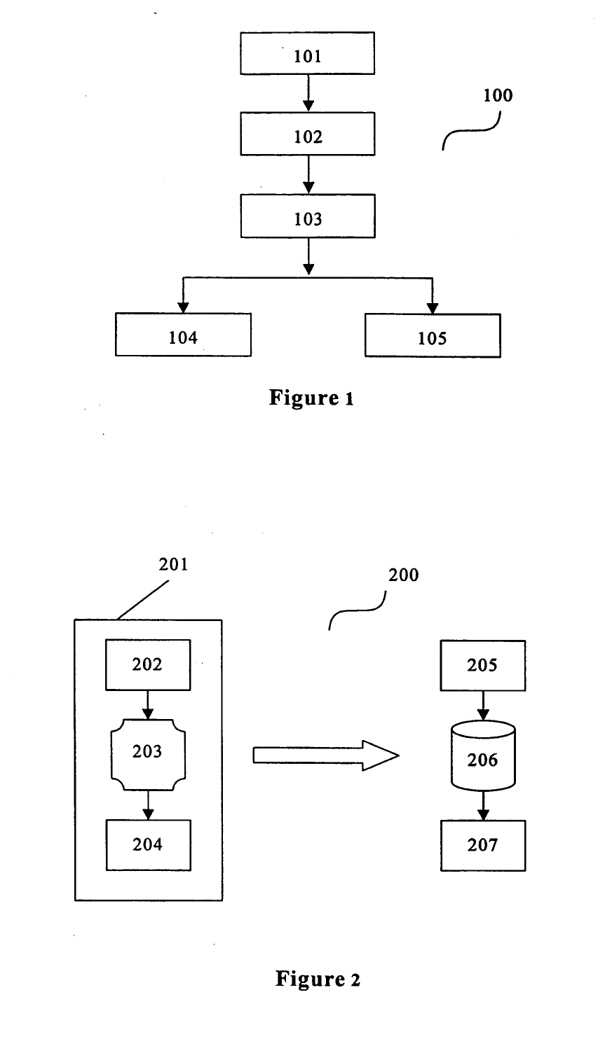

### DETAILED DESCRIPTION OF THE INVENTION

At the present, there is a vast flow of information. This occurs as a result of the growth and development of a number of data communication media. Although this has made information available literally at the press of a button, the limit of human capacity is becoming apparent.

An additional problem has also become apparent with the growth of the Internet and other data communication systems. Communication media are also used for another purpose, in parallel with transmitting core information, using data communication media. This purpose is the transmission of special messages alongside core information. Special messages include advertisements, notifications, legal notices, credit warnings and a host of other items. These messages are both single directional and interactive between sender and targeted recipients.

Typically, in Internet Web sites, it has become commonplace to have a variety of special messages. These include advertisements with or without hyper-linking to other Web sites or other Web pages, warnings, legal notices and credit control notices and a host of others. Similarly, cellular telephones SIM cards carry text and audio special messages. In addition, credit card databases carry credit-warning messages and telephone system databases carry audio and text messages and warnings. In much the same way, magazines and newspapers carry special text and graphic messages in the form of advertisements, legal notices and so on.

The amount and proportion of such special messages that can be carried in a media site is limited by aesthetic, physical and financial considerations. These considerations may be expressed as the ratio of the amount of non-core special message information to the quantity of core information. When the proportion of non-core information reaches a point of unacceptability to a viewer, listener or reader, this point is termed saturation.

This saturation is financially limiting to media. Many methods are used to extend this saturation point, for example, by using hyperlinks on a Web site, by adding supplements to newspapers or magazines, by adding special message supplements to credit card billing and many others. These techniques merely appear to delay the onset of saturation but are often ineffective.

In some situations, for financial considerations, it is impractical to extend the physical size of media sites. Therefore, a magazine may be limited to a specific number of pages and a Web site to a specific number of Web pages.

Equally, aesthetics of any media site have to be taken into consideration. Readers, listeners or viewers must not overwhelmed with the multiplicity and density of information represented by over-saturation. This makes a media appear unfriendly and overwhelming. There is, then, a need for a method to reach beyond this point of saturation in a media without creating over-saturation.

According to the core-technology embodiment of the super-saturation method for information-media of the present invention, whereby a second information-media broadcaster in conjunction with an agency extends a content presentation of a first broadcaster beyond a predetermined information-media saturation threshold for content presentation of the first broadcaster, the instant invention method is including the steps of: (A) facilitating 101 (an agreement between the first broadcaster and second broadcaster allowing) visitor identification and visitor-file supervision by an agency; (B) tagging, 102 by a first broadcaster 105 of a first information-media in conjunction with the agency, a preponderance of visitors to the first information-media with a tag—wherein said tag corresponds to an agency supervised visitor-file and the respective visitor-file has at least one visitor relevant data-aspects therein; (C) recognizing 103, by a second broadcaster of a second information-media in conjunction with the agency 104, a visitor to the second information-media as having a tag—wherein said tag corresponds to the agency supervised visitor-file; (D) accepting, by the second broadcaster in conjunction with either the agency or the first broadcaster, an offsite content presentation for the recognized visitor and the content is relevant to at least one data-aspect of the respective visitor-file; and (E) presenting the offsite content to the recognized visitor. Furthermore, according to the preferred core-technology embodiment variation of the super-saturation method for information-media of the present invention, at least one of the visitor relevant data-aspects are selected from the list: visitor provided profile disclosure, visitor provided search word, visitor provided search phrase, visitor provided search cluster string, visitor provided image, visitor provided image fragment, visitor provided bio-metric, characterization of content at the first information-media, and characterization of content at a second information-media where-at offsite content was presented using the super-saturation method—such as in accordance with many of the aforementioned examples.

It is a sine qua non that commercial Web sites and other data communication media sites, while presenting core information to specifically targeted viewers, readers or listeners, also insert as much non-core special message information as possible. After all, this is a major revenue source for a site. In addition, non-core special messages are directed at these same specifically targeted viewers, readers or listeners. A targeted group is generally defined as market related to such aspects as age, technical field, sex, profession and many others.

At a commercial site with substantive visitor traffic, there is a demand for space for special message items such as advertisements, notices and so on. If the media site arrives at a point of reaching a predetermined quantum of special message items, that is, reaches a point of saturation, clients requiring additional space for further special messages cannot be satisfied. By insertion of excessive amounts of special messages and consequent over-saturation of a media site, targeted clients will find the sheer volume of data too overwhelming and difficult to maintain interest and to absorb.

It is obviously in the best interest of a proprietor of these media, to place as much and as many special messages into each media presentation as possible, since this is a prime and significant source of revenue. Similarly, clients wishing to place special message items, have a vested interest insofar as directing, for example, advertisements for products or services, to the specifically targeted visitors to this site.

Simply stated, when a media reaches special message saturation, in regard to the present invention, an agency, in conjunction with a suitable second broadcaster, is utilized to extend additional special message content presentation beyond saturation point. The second broadcaster site is selected specifically because this site targets a category of visitors similar to the first broadcaster site. A client advertiser at the direction of the agency for example, places a special message item, prepared, placed into the second broadcaster site. This special message presentation is for presentation to substantially the same targeted-client base but on an off-site basis at an alternative site servicing substantially the same client base.

Tagging of either someone that watches a page or someone that clicked a part of a page (such as an ad) therefore indicating his interest in the provided content. Tagging could also be accomplished by using the ID of the machine used by the user as the anchor of the user's profile in a database. The machine ID could be a cookie, an IP address, a cell phone number, a set top box ID etc.

While the first Broadcaster may be paid by the advertisers per ad view, ad click, lead or transaction, the second Broadcaster that either receive a revenue share from the first broadcaster or a guaranteed payment per ad views will usually translate the revenues it receives into an effective CPM—the price it received for every 1,000 ads it gave the first Broadcaster or any other entity so it will know to which entities it should allocate its ad space in order to maximize its revenues from its ad space.

Super Saturation for Paid Search requires the addition of one more step—the ‘Selection’ step where either the first Broadcaster or the Agency needs to have a selection process in place when the user is qualified to see ads based on different kind of content he visited in the past as observed by the first Broadcaster. These added Selection processes maximize the effective CPM for the first Broadcaster or the Agency.

In cases where the user visited a few first Broadcasters and the Agency needs to choose among a few first Broadcasters, the Agency will decide among the first Broadcasters by comparing the effective CPM given by each of the first Broadcasters to the Agency to be divided among the Agency and the second Broadcaster. For example, a person clicks a ‘Mortgage’ ad from FindWhat (paid search provider) on February 10 and tagged by the agency following a redirect from FindWhat. A week later, on February 17, the person clicks a ‘Health Insurance’ ad from LookSmart (another paid search provider) and tagged by the agency following a redirect from LookSmart. Another week later, on February 24, the agency finds the person on the Fox News site reading a Sports article and has the opportunity to present this person with an ad. Which ad should the agency present the user with ? A ‘Health Insurance’ ad from Looksmart (one first broadcaster) or a ‘Mortgage’ ad from FindWhat (another first broadcaster)? The agency queried the top bids for ‘Mortgage’ at FindWhat at the time of the search (click) for ‘Mortgage’ and the top bid was $10 per click at FindWhat. The agency queried the top bids for ‘Health Insurance’ at Looksmart at the time of the search (click) for ‘Health Insurance’ and the top bid was $3 per click at Looksmart. The agency also knows that the average click-through (‘CTR’) on a ‘Mortgage’ ad 2 weeks following a search for ‘Mortgage’ is 0.5% and the average click-through (‘CTR’) on a ‘Health Insurance’ ad 1 week following a search for ‘Health Insurance’ is 0.75%. The agency therefore calculates the effective CPM, or in other words which ad is expected to generate the highest yield to the agency and Fox News (the 2^{nd} broadcaster). It should be mentioned that FindWhat pays the agency 50% of whatever the advertiser pays it per click while Looksmart pays 60% of the amount paid by the advertiser to the agency. The agency must split, of course, the fee for the click received from the paid search provider with the 2^{nd} broadcaster (Fox News). The effective CPM (ECPM) expected from the ‘Mortgage’ ad is therefore: 1,000 ads * 0.5% CTR * $10 per click * 50% share (of agency & Fox News)=$25 ECPM. The ECPM expected from the ‘Health Insurance’ ad is therefore: 1,000 ads * 0.75% CTR * $3 per click * 60% share (of agency & Fox News)=$13.5 ECPM. The agency will present the ‘Mortgage’ ad from FindWhat since it is expected to generate $25 ECPM to the agency and Fox News versus $13.5 ECPM for the ‘Health Insurance’ ad from Looksmart.

In another example, a person searches for ‘Air fare’ on Google (search engine and paid search provider) and tagged by the agency when reading the search result page following a redirect from Google. A week later the person visits InformationWeek, a $100 CPM tech vertical web site, and tagged by the agency following a redirect from InformationWeek. Another week later, the user is recognized by the agency on MSN reading a general news article. Which ad should the agency present the user with? An ‘Air fare’ ad from Google (one first broadcaster) or an ad from InformationWeek (another first broadcaster)? The agency knows that the CTR for ‘Air fare’ ads 2 weeks following a search for ‘Air fare’ is 1.5% and that the top bid that was queried by the agency from Google at the time of the search at Google was $2 per click and that Google pays 50% of the amount paid by the advertiser to the agency. Therefore the ECPM expected from an ‘Air fare’ ad from Google is: 1,000 ads * 1.5% CTR * $2 per click * 50% share (of the agency & MSN)=$15 ECPM. The agency also knows that InformationWeek sells its advertisers ads to its audience when they are outside its site for $40 CPM and that InformationWeek will pay the agency 30% of the amount paid by the advertiser to be split between the agency and the 2^{nd} broadcaster. Therefore, the agency expects a $40 CPM * 30% share (of the agency & MSN)=$12 ECPM if the agency presents the visitor with the InformationWeek ad. Clearly in this example the agency will present the visitor to MSN with the Google ad as it is expected to generate to the agency and MSN a higher ECPM.

In a different example, an adware company acting as the first broadcaster informs the agency that their software user just visited the travel site ‘Travelocity’ searching for a flight to LA. The agency tags the user and knows that the next time it has the opportunity to show an ad to this person within the next 14 days it could show an ad for hotels in LA from Expedia, a travel site that competes with Travelocity and that will pay $10 CPM for the ad. The next day the adware company informs the agency that the same software user has just searched on Google for ‘Health Insurance’. The agency tags the user for future recognition and queries two paid search providers it is working with to check what are the top bids for ‘Health Insurance’ there. The first paid search ad provider top bidder for ‘Health Insurance’ offers $4 per click while the second paid search ad provider top bidder for ‘Health Insurance’ offers $3 per click. The agency also knows that the first paid search ad provider pays 60% of the amount paid by the advertiser to the agency and the second paid search ad provider pays 70%. The agency recognizes the same person a week later on MSN general news. The agency has an agreement in place with MSN that it can filter the MSN audience and if it chooses to show an ad to an MSN visitor the agency will pay MSN $5 CPM. The agency needs to decide if to serve an ad at all since it needs to pay $5 CPM to MSN if it shows the ad and it is also required to pay the first broadcaster (the adware company) 50% of what ever the agency is left with after paying the ₂nd broadcaster (MSN). Also, if the agency decides to serve an ad at MSN, it needs to decide whether to serve the ad from the first paid search ad provider or the second paid search ad provider or from Expedia. The agency knows that the CTR on a ‘Health Insurance’ ad a week following a search for ‘Health Insurance’ is 0.75%. The agency will receive the following EPCM from the first paid search ad provider: 1,000 ads * 0.75% CTR * $4 per click * 60% share (of agency, MSN and adware company)=$18 ECPM. The agency will receive the following ECPM from the second paid search ad provider: 1,000 ads * 0.75% CTR * $3 per click * 70% share (of agency, MSN and adware company)=$15.75 ECPM. Clearly, it is worthwhile for the agency to show an ad to the visitor at MSN in return for $5 CPM and of course the ad will originate from the first paid search ad provider that is expected to generate $18 ECPM versus $15.75 ECPM from the second paid search ad provider and $10 from Expedia.

To reach this client base, the first broadcaster in conjunction with the agency enters into an arrangement. Substantially all clients visiting the first broadcaster are tagged at the instance of this broadcaster. For example, a cookie is inserted into a visitor's browser or similar tags are placed into a customer database.

Recognition of this tag occurs, in accordance with an arrangement between an agency and both first and second broadcasters, when a tagged visitor requests a visit to the second broadcaster site. Recognition of such a tag gives rise, in conjunction with the agency or in conjunction with the first broadcaster, to several possibilities. For example, in an Internet situation, a recognized visitor is presented with the first broadcaster's special message, situated in the second broadcaster. Alternatively, the visitor fetches a special message from the second broadcaster. Similarly, this special message is placed into a cellular SIM card database, targeted at a client base appropriate to the first broadcaster. Another possibility is the use a telephone system database to elicit a similar result.

According to the core-technology embodiments, the first information-media or the agency or the first broadcaster tags the person making the search. The search engines and the paid search providers derive a big portion of their traffic through affiliate sites to whom they provide the search results and the paid search ads via XML. The search engines and the paid search providers get ‘access’ to the person making the search so they could tag him for future recognition only if they click the search content or the paid search ads that they provided. For example, a person is visiting a site with a search functionality. In response to a search made by the visitor, the site's server issues a call with the search query (made by the user) to the search engine's server and to the paid search provider's server via XML. The search engine's server responds to the call by sending the relevant search results back to the site's server via XML. The paid search provider's server responds to the call by sending the relevant paid search ads back to the site's server via XML. The site's server receives the search results and the paid search ads via XML (or any other current or future protocol) and integrates them into the page.

The net consequence of using the method of the present invention is that all parties to this method are satisfied. The client advertiser has exposure to a targeted visitor group. The first broadcaster, in spite of being saturated with inserted message items, is able to reach a situation of super-saturation and, consequently, benefit financially. The second broadcaster receives additional revenue with the addition of special message items. Finally as a result of this application of the present invention, the agency benefits in a role as facilitator and coordinator.

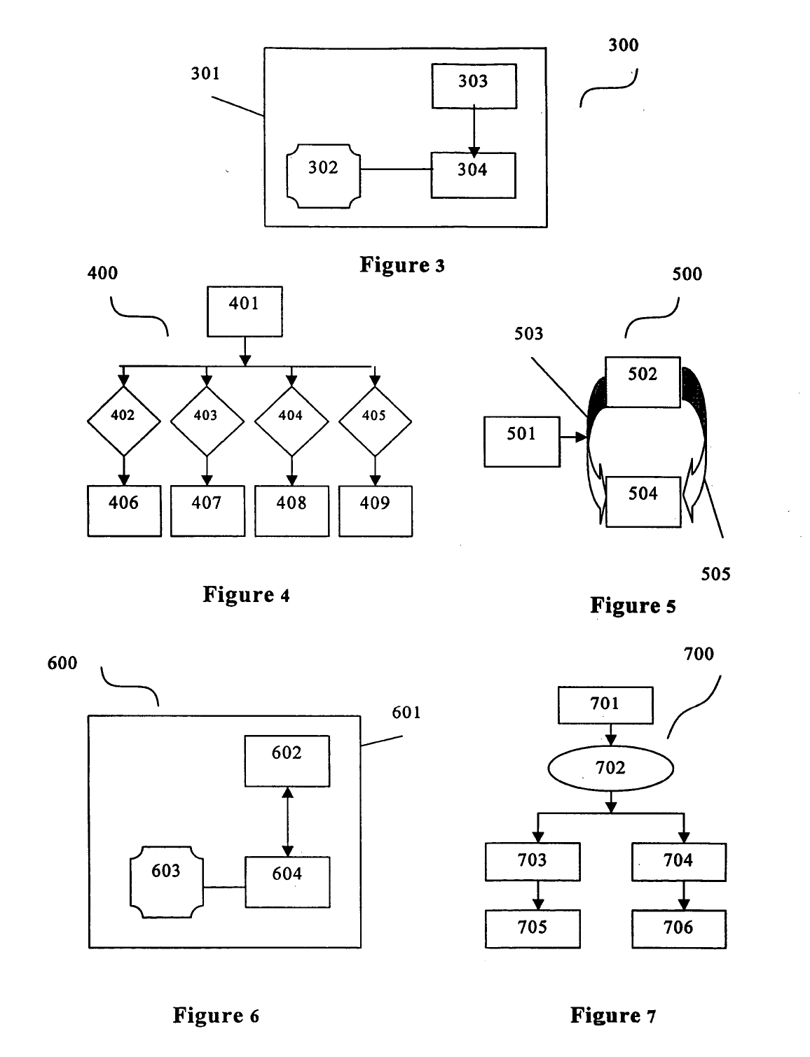

Turning now to FIGS. 2-7, these illustrate schematically aspects of a contracting structure for facilitating super-saturation of an information-media. FIG. 2 illustrates a schematic view 200 of a first contractual agreement 201. FIG. 3 illustrates a schematic view 300 of a second contractual arrangement 301. FIG. 4 illustrates a schematic view 400 relating to a first broadcaster providing 401 a facilitated tagging 402, 403, 404 and 405 of a preponderance of visitors 406, 407, 408 and 409 to the first information-media. FIG. 5 illustrates a schematic view 500 relating to an agency 502 providing 503 a facilitated offsite placement 501 of a content deriving from the first contractual agreement, the agency paying 505 the first broadcaster 504. FIG. 6 illustrates a schematic view 600 relating to a third contractual agreement 601. Finally FIG. 7 illustrates a schematic view 700 relating to details of this third contractual agreement.

The present invention also relates to a contracting structure for facilitating super-saturation of an information-media, whereby a second information-media broadcaster in conjunction with an agency extends a content presentation of a first broadcaster beyond a predetermined information-media saturation threshold for content presentation of the first broadcaster, the contracting structure including:
a first contractual agreement 201 between an agency offering 202 an offsite content presentation 203 for a first information-media and a content provider accepting 204 said offering;
whereby the agency provides a facilitated delivery 205 of a content 206 of the first content provider to an identified visitor visiting 207 offsite; and
whereby the content provider pays for the facilitated delivery;
a second contractual agreement 301 between the agency 303 and a first broadcaster 304 of the first information-media 302;
whereby the first broadcaster 401 provides a facilitated tagging 402, 403, 404 and 405 of a preponderance of visitors 406, 407, 408 and 409 to the first information-media; and
whereby the agency 502 provides 503 a facilitated offsite placement 501 of a content deriving from the first contractual agreement, the agency paying 505 the first broadcaster 504 for substantially each such facilitated placement; and
a third contractual agreement 601 between the agency 602 and a second broadcaster 604 of a second information-media 603;
whereby the second broadcaster provides 701 a facilitated recognizing 702 of a visitor to the second information-media as having the tag, and thereupon by proxy—either in conjunction with the agency 703 or in conjunction with the first broadcaster 704—the second broadcaster provides a facilitated accepting 705 and 706 the offsite content presentation for the recognized visitor; and whereby the agency pays for the facilitated delivery accepting.

Simply stated, the basis for this contracting structure is that a first broadcaster has reached a point of special message saturation. Another broadcaster in a second information-media, in conjunction with an agency, extends a special message content presentation on behalf of the first broadcaster. Therefore, the first broadcaster, in effect, reaches a content presentation beyond a predetermined information-media saturation threshold, or a state of super-saturation.

According to an embodiment of the present invention, a contracting structure consists of three separate contracts. A first contractual agreement is between an agency offering, for example, to an advertiser or a credit card organization, respectively, an insertion of an advertisement or a credit warning into an offsite media. This offer arises as a result of a first broadcaster being unable to accommodate additional insertions, that is, being at a point of saturation. The agency includes, in terms of this contract, a provision for delivering the inserted item to an identified offsite visitor. The advertiser pays the agent for this service. Furthermore, it is also conceivable that the first broadcaster is the content provider.

A second contract is between the agency and a first broadcaster; in this case, the broadcaster that has reached saturation point, for insertion of additional items. The first broadcaster thus reaches a situation described by the present invention as super-saturation. The broadcaster agrees to provide tagging of substantially all visitors to this first media site. Further, the agency agrees to provide an alternative site for facilitating identified visitors from the first broadcaster site receiving the inserted item on visiting the second site. The agency pays the first broadcaster in terms off this contractual arrangement.

Finally, the agency enters into a third contract with a second broadcaster. In terms of this contract, in conjunction with either the agency or the first broadcaster, the second broadcaster provides a procedure for recognizing a tagged visitor to the second media. This procedure includes the visitor accepting the offsite presentation item. The agency pays the second broadcaster for accepting this item. In ‘real life’ there will be 3 core embodiment agreements: between the agency and the ad provider, the agency and the search info provider (what the user searched for) (=first broadcaster) and the agency and the ad space owner (second broadcaster). In terms of these three contracts, the first broadcaster benefits from selling a placement of an advertisement, a notification or other insertion into an alternative site. In spite of the first broadcaster being at a saturation point, by providing tagging to visitors to this first site, the first broadcaster provides the advertiser with a preponderance of first site visitors. These visitors are able to receive this message item at another appropriate site. The agency pays the second broadcaster for placing insertions on behalf of the other site (or the advertiser) for acceptance by visitors tagged at the first site. The advertiser benefits by having an advertisement, albeit at the second site, nevertheless targeted at visitors to the saturated first broadcaster site. The net proceeds from these contracts, of course, will accrue to the agency, which has acted as a facilitator and coordinator in terms of the contracts for this super-saturation method.

As will be understood by a man of the art, the terminology in relation to Internet Web Site usage, of the phrase “Cost Per Thousand” (CPM) is used by Internet marketers to price advertising banners. Sites that sell advertising will guarantee an advertiser a certain number of impressions (number of times an advertising banner is downloaded and presumably seen by visitors.), then set a rate based on that guarantee times the CPM rate. A Web site that has a CPM rate of $25 and guarantees advertisers 600,000 impressions will charge $15,000 ($25×600) for those advertisers' advertising banner.

By way of an example of the embodiments of the present invention, in a case of a ‘highly-valued’ section (i.e. Financial section) of a particular site, advertisements sell for $50 CPM. Advertisement space in this section is often sold out. However, another section of that site devoted to General News sells for only $10 CPM and is usually unsold. If a user browses the Financial section and then goes to the General News section, the user will be recognized by the agency as a Financial section visitor, ‘interested in Finance’. Because advertisers are willing to pay a premium to reach the ‘interested in finance’ person, portions of the inventory in the General News section may now be sold by the site for $35 instead of for the traditional $10.

A further example relating to the embodiments of the present invention wherein a publisher sells visitors to its lucrative/sold-out site sections to its advertisers but on other web sites, as yet not sold-out. The as yet not-sold-out web sites rent their substantially unsold space to be sold by publishers to their own advertisers through an agency. For example, assuming that a publisher's Personal Finance section is sold out at $50 CPM. Visitors to this section will inevitably visit other content sites. The publisher's sales force, which already has the expertise to sell to the Personal Finance section audience, can now sell these Personal Finance section visitors to its own advertisers for $30 when those visitors surf other sites, thus providing the Publisher with a new revenue stream.

In this next example, a publisher's unsold space is sold by other publishers as offsite space to their own advertisers. A technology related publisher, for example, may charge $60 CPM for advertising on its web site. However, the technology related publisher could charge its advertisers $45 CPM in return for showing offsite advertisements to the publisher's regular site audience. More simply stated, the technology related publisher will charge its advertisers $45 CPM in return for showing advertisements to its site audience while they visit other web sites.

The publisher, which in its unsold space the technology related publisher audience was found, can charge through the agency, a fixed CPM or take a percentage of the revenues from the technology related publisher that used its advertising space to serve offsite advertisements to its own audience on behalf of its advertisers. Following these examples it is emphasized that as a publisher an important target is earn a new revenue stream without cannibalizing current revenues or devaluing currently selling advertising. Selling offsite advertisements is a significant improvement to the art. For example, selling a bundle of 10 exposures to advertisements within a site for $45 CPM and 100 exposures offsite for a $30 CPM, represents a significant revenue source. In the context of a “Search”, the advertiser may pay for out of context more, equal or less than for in-context ad. Worth noting that people spend less than 5% of their time searching and over 95% of their time online browsing different kind of content, reading web based e-mails etc. while at the same time the demand for paid search ads is constantly growing and therefore Super Saturation is very important as it provides the advertisers, the search providers and publishers with ad space—with new opportunities to present people with paid search ads wherever they happen to be on the web for the benefit of all parties including the visitor him self that views relevant ads.

According to an embodiment of the present invention, the super-saturation method for information-media, the agency is an advertising agency. In this capacity, an agency provides know-how and experience in advertising and in marketing of advertising media in a variety of fields such as the Internet, radio, television and news media. According to another embodiment of the present invention, the super-saturation method for information-media, the agency is a credit agency.

An important aspect of commerce includes controlling and regulating credit facilities. A credit agency is in a position to assist clients requiring to regulate customer credit lines. This can be accomplished in accordance with the present invention by utilizing notifications into a variety of media, such as telephone and cellular telephone databases.

According to an additional embodiment of the present invention, the super-saturation method for information-media, the agency is a public service organization. Public service organizations are often called on to assist members of the public in a large range of problems. These include, for example, finding a lost pet, tracing missing persons, assisting old-age pensioners and so on. Placing notifications in available media is pertinent to resolving such problems.

According to a further embodiment of the present invention, the super-saturation method for information-media, the agency is a legally empowered body. A multiplicity of legal matters form part of today's relationships with bodies such as banks, home loan institutions, adoption agencies and many others. Inevitably, legal matters include placing of various notices including notices of advisement, warning, information and a host of others. Access to all media is an important aspect for any legally empowered body.

According to an alternative embodiment of the present invention, the super-saturation method for information-media, the agency is a media agency. A media agency has a distinct advantage in dealing with not merely a multiplicity of media, but also advertisers, core information providers, and others. This is important in promoting relationships between advertisers, a substantial array of broadcasters, and other participants in relation to the present invention.

According to other embodiments of the present invention, the super-saturation method for information-media, the agency is a cellular telephone service or a wireless communication service or the likes. Agencies, in order to be able to form a liaison between advertisers and media broadcasters, need to have a working knowledge of the field of interest. Clearly, enterprises offering cellular telephone services and wireless communication services are able to provide access to a database of customers as well as access to related telephone and other communication media.

According to an added embodiments of the present invention, the super-saturation method for information-media, offering includes selling or renting or leasing or trading or proposing for payment or the likes. When an agency becomes aware of a saturation situation at a media broadcaster, the agency makes proposals to prospective advertisers, notification organizations and others with regard to arranging media space. These special message insertions into appropriate media, related to a saturated media site, are negotiated from an offering, selling, renting and selling perspective. Included in this negotiation as part of offering are also trading between media sites and arrangements regarding payment.

According to an added embodiment of the present invention, the super-saturation method for information-media, the offsite content presentation is an advertisement presentation. Advertisements are commercially important in promoting products and services. Insertion of successful advertisements is ideally made into media sites where core information or personnel are generally involved in related fields. There are many instances, however, where this is not necessary, for example, advertisements for insurance, restaurants, entertainment, etc. have a very general appeal. Therefore, offsite presentations can be made effective by judicious site selection.

For example, people involved with finance and business generally read a financial section of a newspaper. Therefore, a luxury car advertisement is logically shown in that section. If, however, the financial section reader is identified while reading the general news section, the luxury car advertisement is shown to him again.

According to another embodiment of the present invention, the super-saturation method for information-media, the offsite content presentation is a notification. Notifications generally relate to personnel or core information on a site. Therefore notifications regarding a lost pet, dog licensing requirements, etc. are appropriate to, for example, a magazine dealing with animals, dos and cats, and so on. Notifications of expiry of a media service are ideally made on a service offering the media service such as a cellular or wireless network.

According to a variation of an embodiment of the present invention, the super-saturation method for information-media, the notification is a public service announcement. An example of this type of notification is using a particular regional telephone exchange to advise of some change in municipal services such as refuse removal, power cuts and water system repairs.

According to another variation of an embodiment of the present invention, the super-saturation method for information-media, the notification is a personal reminder. The local telephone service and more recently, cellular telephone services have provided personal reminder notifications of many types. For example, wake-up calls, appointment reminders, etc.

According to further variations of an embodiment of the present invention, the super-saturation method for information-media, the notification is a judicial instrument or a credit warning or the likes. Notifications cover an enormous selection of devises. Examples of these relate to bankruptcy, missing persons, meeting times, excessive spending on a credit card account, marriage, divorce, to name just a few.

According to an added embodiment of the present invention, the super-saturation method for information-media, the offsite content presentation is a graphic item. Graphic presentations are used in many information-media due to the eye-appeal to the reader and viewer. Examples of graphic presentations, in the context of the present invention, include news photographs, graphical advertising presentations, promotional items, catalogues, cartoons and many more

According to other embodiments of the present invention, the super-saturation method for information-media, the offsite content presentation is a multimedia presentation or is an audio presentation or is a banner or is a personalized media presentation (in accordance with attributes known to the agency supervised visitor file or the likes. Offsite presentations are not limited to merely text or graphic visual effects but include multimedia, audio and banner presentations. These are made up of movie clips, video productions and banners, either as stationary items or as moving presentations.

According to a supplementary embodiment of the present invention, the super-saturation method for information-media, the first information-media is an Internet data communications media. The Internet represents, in many respects, a rapidly growing communication media accessed by very large numbers of people. Internet sites vary in accordance with core information so that advertisements and any other notifications can be directed at very specific targeted groups of people. Substantially all aspects of the present invention relate well to use in this media, but, are not, by any means, restricted to it.

According to another variation of an embodiment of the present invention, the super-saturation method for information-media, the Internet data communications media includes at least one content presentation of a plurality of content presentations. An implication of this embodiment relates to a concept that offsite presentations are not necessarily limited to a single presentation, nor to a presentation being limited to a single site or even to a single media.

According to an added embodiment of the present invention, the super-saturation method for information-media, the first information-media is an interactive data communications media. According to additional variations of an embodiment of the present invention, the super-saturation method for information-media, the interactive data communication media is a telephone communication media or a wireless communication media or a cellular communication media or the likes. In the past, advertising and placing of notices was a one-way information transference. An interesting development in the use of Internet advertising and notification techniques is the extent of possible interactivity. This is certainly also the case in many other media such as cellular, wireless and telephone media. By being easily and readily interactive, these media provide users with the possibility of quick responses to notifications.

According to an added embodiment of the present invention, the super-saturation method for information-media, the first information-media is a broadcasting media. Radio and television broadcasting are the oldest of the electronic communication media. These have been used both by core information presenters and advertisers, to present information to selected groups of people. This is especially true with regard to program material targeting specific population groupings based on selection techniques such as time of presentation.

According to a further embodiment of the present invention, the super-saturation method for information-media, the first information-media is a hyperlink. Hyperlinks are a very useful way to convey offsite notifications to targeted visitors. Hyperlinks are commonly used for placing advertising links to source presenters. This is achieved also by a broadcaster using a hyperlink to send a presentation item to a visitor's browser or to cause a visitor to fetch the presentation.

According to an alternative embodiment of the present invention, the super-saturation method for information-media, the first information-media is a banner. Banners are commonly used in a wide selection of media, including magazines, newspapers, bills, internet sites and others. These are usually brief and are an ideal media for drawing attention to other media, other advertisers and so on. Banners are also used for presenting hyperlinks and as a separate media presentation for notices of many types. Banners are used in virtually every communication media and supply a convenient brief communication media. Banners take a form such as headers in a newspaper and magazines, announcements in cellular voice mail systems, presentations in Internet sites, and so on.

According to an additional embodiment of the present invention, the super-saturation method for information-media, the first broadcaster has an association with an interactive data communication media.

According to another embodiment of the present invention, the super-saturation method for information-media, the first broadcaster is a Web site on an Internet data communication media. Sites in this scenario relate to, for example, dissemination of information, news, scientific data, entertainment and many others. Use of added insertions of advertising and notifications includes examples such as insurance promotion, banking, personal notices, product availability, and legal advisements, to name but a few.

According to an added embodiment of the present invention, the super-saturation method for information-media, the first broadcaster is an advertising media. There are already many Web sites relating exclusively to product and service promotion. These are not necessarily limited to a single product or service, or even a single range of products or services. In many cases, a range of goods and services is quite general. In some cases, broadcasters that are essentially advertising media, use appropriate core presentations as a base for advertising presentations.

According to an embodiment of the present invention, the super-saturation method for information-media, the first broadcaster is a credit agency. These sites relate to placing warning messages and informative notices relating to creditworthiness and to financial status of a range of commercial enterprises and individuals.

According to an embodiment of the present invention, the super-saturation method for information-media, the first broadcaster is a credit control agency for a credit card organization. Such a broadcaster, in the current embodiment context, will make use of a credit card organization database to direct notices to credit card users as well as to suppliers accepting payment by credit card. These notices generally relate, on the one hand to warnings regarding overspending or underpayment by card users, and, on the other hand, warning to suppliers. However, additional uses include promotional additions to billing documents and to information brochures.

According to further embodiments of the present invention, the super-saturation method for information-media, the first broadcaster is a banner promotion agency or a public service organization or the likes. Public service organizations provide a wide range of services, for example, to the elderly and infirm, to children, to unmarried mothers, financial and charity, and many others. Many such organizations publish web sites, magazines, newsletters and so on. Many include advertisements and a host of other notices.

According to an embodiment of the present invention, the super-saturation method for information-media, the first broadcaster is a legally empowered body. A classic example of such a body is the revenue service although there are others such as the Society for the Protection of Animals, child protection agencies, pension and social benefit bodies, to name a few.

According to other embodiments of the present invention, the super-saturation method for information-media, the first broadcaster is a media agency or a cellular telephone service provider or a wireless communication media or the likes. All the aforementioned media are able to utilize the present invention for promotional, advertising and notification to their customer base. This represents a large number of individuals and enterprises, which can be grouped into targeted databases. Advertising and notification messages are then sent to specifically targeted groups.

According to an embodiment of the present invention, the super-saturation method for information-media, the first broadcaster is a hyperlink. A hyperlink provides a route for easy access to anywhere on the World Wide Web. Apart from a particular link, access is available to specific sites and to specific groups of sites having similar core information or similar areas of interest, for example, a group of sites relating to philately, dog breeding, hunting, and medicine, to name a few.

According to an embodiment of the present invention, the super-saturation method for information-media, tagging a preponderance of visitors includes placing a cookie into each visitor of the preponderance of visitors.

According to a variation of an embodiment of the present invention, the super-saturation method for information-media, in which placing a cookie into each visitor of the preponderance of visitors includes placing an identification message into each visitor's web browser when the visitor requests a page. A cookie is a message given to a Web browser by a Web server. The browser stores the message in a special text file. This message is sent back to the server each time the browser requests a page from the server. This cookie then provides an identification of the visitor.

According to other embodiments of the present invention, the super-saturation method for information-media, tagging a preponderance of visitors includes placing a notification into a telephone system database for each visitor of the preponderance of visitors, or includes placing a message identifier record into a database for each of the preponderance of visitors, or the likes. In these instances, effectively, a result similar to using a cookie is achieved. However, instead of using the Web, a media database is utilized.

According to an embodiment of the present invention, the super-saturation method for information-media, tagging a preponderance of visitors includes placing a credit warning into a credit-card database for each visitor of the preponderance of visitors. Notifying credit card users of overspending and underpayments are often used warnings. Notices are appended to credit card billing, sent to cardholders via merchants at the time of a transaction, and so on. Notices are also of an informative and promotional nature to encourage additional card use.

According to an embodiment of the present invention, the super-saturation method for information-media, tagging a preponderance of visitors includes placing a personal notice into a public service database for each visitor of the preponderance of visitors. Notices for lost and found items, personal matters and many others are not uncommon uses for this media. Searching for long-lost relatives is another example. These are, naturally, conveyed to people to whom such notices are pertinent.

According to an embodiment of the present invention, the super-saturation method for information-media, tagging a preponderance of visitors includes sending a legal instrument into a legally empowered body database for each visitor of the preponderance of visitors. The database at such legally empowered body databases enable authorized personnel to trace failure to submit tax returns, failure to pay family maintenance, non-payment of traffic violation fines, and many others.

According to an embodiment of the present invention, the super-saturation method for information-media, tagging a preponderance of visitors includes placing a message into a cellular telephone SIM card for each visitor of the preponderance of visitors.

According to an embodiment of the present invention, the super-saturation method for information-media, tagging a preponderance of visitors includes placing a notification into a wireless communication service database for each visitor of the preponderance of visitors. These databases are useful predominantly to the enterprise owning the database. However, these are also commonly used for advertising notices, product and service promotions, etc.

According to an embodiment of the present invention, the super-saturation method for information-media, each visitor of the preponderance of visitors to the first information-media is classified as a preferred visitor.

According to a variation of an embodiment of the present invention, the super-saturation method for information-media, wherein the preferred visitor includes each visitor of the preponderance of visitors classified as a preferred visitor remaining at the first information-media for a predetermined period of time.

According to a variation of an embodiment of the present invention, the super-saturation method for information-media, wherein each visitor of the preponderance of visitors classified as a preferred visitor includes a visitor spending a predetermined amount of money at the first information-media. In order to reach substantially the same targeted group of visitors at a second site, a tag is placed into specific visitors to the first site. Visitors are evaluated, according to particular criteria, and only those evaluated as preferred and are tagged. Generally, these criteria relate to time spent at the first site and to money spent. However, other criteria can be set such as, for example, replies to special questionnaires, responses to specific details, reaction to predetermined aspects of the first site etc.

According to still other embodiments of the present invention, the super-saturation method for information-media, the tag is a cookie or an identification message or a notification in a telephone system database or a message identifier record in a database or a credit warning in a credit card database or a personal notice in a public service database or a legal instrument in a legally empowered body database or a message in a cellular telephone SIM card or a notification into a wireless communication service database or the likes. Generally, tags and the process of tagging have mutatis mutandis, been described heretofore in relation to tagging.

According to an embodiment of the present invention, the super-saturation method for information-media, the second broadcaster has an association with an interactive data communication media.

According to still further embodiments of the present invention, the super-saturation method for information-media, the second broadcaster is a Web site on an Internet data communication media or is an advertising media or is a credit agency or is a credit control agency for a credit card organization or is a banner promotion agency or is a public service organization or is a legally empowered body or is a media agency or is a cellular telephone service provider or is a wireless communication media or is a hyperlink or the likes. With respect to the second broadcaster, comments already made in regard to the first broadcaster are mutatis mutandis equally applicable here, given regard to the fact that both broadcaster can operate on the same or on different media.

According to an embodiment of the present invention, the super-saturation method for information-media, in which in conjunction with the agency the second broadcaster accepting the offsite content presentation, includes receiving an advertisement presentation. This offsite presentation relates to, for example, an advertisement presentation, a notification, a warning, a judicial notice and so on. This presentation would have been found in the first broadcaster site but for the first broadcaster having reached a point of saturation. The present invention provides a method for visitors to the first site, to receive these presentations at another site. This is achieved as a consequence of an agency coordinating tagging of visitors by the first broadcaster and coordinating with the second broadcaster recognizing each tagged visitor.

According to other embodiments of the present invention, the super-saturation method for information-media, in which in conjunction with the agency the second broadcaster accepting the offsite content presentation, includes receiving a public service announcement or receiving a personal reminder or receiving judicial instrument or receiving a credit warning receiving a graphic item or receiving a multimedia presentation or receiving an audio presentation or receiving a banner or receiving similar. In the accepting the offsite presentation, it is implicit that the second broadcaster is providing tagged visitors, from the first site, with access to presentations which otherwise would have appeared in the first broadcaster. The reason for the second broadcaster providing this service relates primarily to a state of saturation in the first broadcaster. This relationship between first and second broadcaster is facilitated by an agency that has an association with both broadcasters, and, particularly to the needs of advertisers in the first broadcaster. It is this knowledge that allows the agency to provide a suitable second broadcaster with a similar targeted customer base to the first broadcaster. It is this that makes offsite promotional and advisory notices in a second broadcaster, of interest to both first broadcaster and to advertisers.

According to an embodiment of the present invention, the super-saturation method for information-media, in which in conjunction with the agency the second broadcaster accepting the offsite content presentation for the recognized visitor includes the second broadcaster dropping the offsite content presentation into a browser of the visitor. According to an embodiment of the present invention, the super-saturation method for information-media, in which in conjunction with the agency the second broadcaster accepting the offsite content presentation for the recognized visitor includes the second broadcaster sending a browser of the visitor to fetch the offsite content presentation. Both dropping the offsite presentation into a visitor as well as sending the visitor to fetch offsite presentation are techniques usable by browsers in relation to the Internet. Similar procedures are possible in most other media. For example, insertion of appropriate data into a cellular telephone SIM card will advise a user regarding some presentation and equally will advise the user to proceed to some other media to fetch this information. Similar applications are feasible in regard to credit card users to mention just a few.

According to an embodiment of the present invention, the super-saturation method for information-media, in which in conjunction with the agency the second broadcaster accepting the offsite content presentation for the recognized visitor includes the second broadcaster sending the offsite content presentation to the recognized visitor via the second information-media. Generally, substantially all comments and descriptions regarding interaction between an agency and the second broadcaster, apply mutatis mutandis to interaction of the first broadcaster in conjunction with the second broadcaster. However, negotiations between these broadcasters are made directly without the liaison assistance of an agency.

According to further embodiments of the present invention, the super-saturation method for information-media, in which in conjunction with the first broadcaster the second broadcaster accepting the offsite content presentation, includes receiving an advertisement presentation or receiving a public service announcement or receiving a personal reminder or receiving judicial instrument or receiving a credit warning or receiving a graphic item or receiving a multimedia presentation or receiving an audio presentation or receiving a banner or receiving similar.

According to an embodiment of the present invention, the super-saturation method for information-media, in which in conjunction with the first broadcaster the second broadcaster accepting the offsite content presentation for the recognized visitor includes the second broadcaster dropping the offsite content presentation into the browser of the visitor.

According to an embodiment of the present invention, the super-saturation method for information-media, in which in conjunction with the first broadcaster the second broadcaster accepting the offsite content presentation for the recognized visitor includes the second broadcaster sending the browser of the visitor to fetch the offsite content presentation.

According to an embodiment of the present invention, the super-saturation method for information-media, in which in conjunction with the first broadcaster the second broadcaster accepting the offsite content presentation for the recognized visitor includes the second broadcaster sending the offsite content presentation to the recognized visitor via the second information-media.

According to an embodiment of the present invention, the super-saturation method for information-media, the second information-media and the first information-media constitute a single media. For example, a lucrative section (advertising sold out) and a non-lucrative section (advertising space available) of a single Internet web-site.

Various descriptive and definitive comments made regarding the first information-media apply mutatis mutandis to the second information-media. While these media can be different types of media, these can equally be the same media. This will commonly be the situation when using the Internet but this applies also to, for example, telephone, wireless and cellular networks. In addition, it is also feasible that the content provider is the first information-media; since it is not specifically necessary for a host and a service provider and a site to be the same entity.

According to an embodiment of the present invention, the super-saturation method for information-media, the second information-media is an Internet data communications media. According to a variation of an embodiment of the present invention, the super-saturation method for information-media, the Internet data communications media includes at least one content presentation of a plurality of content presentations such as a web site or a multi-media down load or a channel of updated information or web radio or web television.

According to an embodiment of the present invention, the super-saturation method for information-media, the second information-media is an interactive data communications media. According to variations of an embodiment of the present invention, the super-saturation method for information-media, the interactive data communication media is a telephone communication media or is a wireless communication media or is a cellular communication media or is a broadcasting media.

According to further embodiments of the present invention, the super-saturation method for information-media, the second information-media is a hyperlink or is a banner.

According to other embodiments of the present invention, the super-saturation method for information-media, in which recognizing a visitor to the second information-media includes accessing a cookie.

According to an embodiment of the present invention, the super-saturation method for information-media, in which recognizing a visitor to the second information-media includes receiving an identification message or querying a notification in a telephone system database or identifying a message identifier record in a database or receiving a credit warning in a credit card database or searching for a personal notice in a public service database or querying a legal instrument in a legally empowered body database or searching for a message in (conjunction with the use of) a cellular telephone SIM card or finding a notification into a wireless communication service database. It is an essential part of the present invention that in recognizing a visitor to the second information-media, a notification is found by the second broadcaster that had been placed in the visitor by the first broadcaster. The second broadcaster needed to provide this identification and recognition system to facilitate the concept of offsite advertising and the inserting of other notifications. There is an equivalence in these notifications, for example of a cookie in an Internet browser, a message emanating from a cellular telephone media database, a credit card warning emanating from a credit card users database, etc.

The instant invention also relates to embodiments of a system including computer usable media having computer readable program code embodied therein for a super-saturation method for information-media, the computer readable program code comprising: (A) a first computer readable program code for causing an agency to facilitate visitor identification and visitor-file supervision; (B) a second computer readable program code for tagging, by a first broadcaster of a first information-media, in conjunction with the agency, a preponderance of visitors to the first information-media with a tag—wherein said tag corresponds to an agency supervised visitor-file and the respective visitor-file has at least one visitor relevant data-aspects therein; and (C) a third computer readable program code for recognizing, by a second broadcaster of a second information-media in conjunction with the agency, a visitor to the second information-media as having a tag—wherein said tag corresponds to the agency supervised visitor-file; for accepting, by the second broadcaster in conjunction with either the agency or the first broadcaster, an offsite content presentation for the recognized visitor and the content is relevant to at least one data-aspect of the respective visitor-file; and for presenting the offsite content to the recognized visitor.

According to the preferred embodiment, the at least one of the visitor relevant data-aspects are selected from the list: visitor provided profile disclosure, word or phrase searched by the visitor as observed by the first broadcaster in conjunction with the agency, visitor provided search word, visitor provided search phrase, product or service the visitor is interested in as observed by the first broadcaster in conjunction with the agency, visitor provided product or service he is interested in, visitor provided search cluster string, visitor provided image, visitor provided image fragment, visitor provided bio-metric, characterization of content at the first information-media, and characterization of content at a second information-media where-at offsite content was presented using the super-saturation method.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A super-saturation method for information-media, whereby a second information-media broadcaster in conjunction with an agency extends a content presentation of a first broadcaster beyond a predetermined information-media saturation threshold for content presentation of the first broadcaster, the method including the steps of: (A) facilitating visitor identification and visitor-file supervision by an agency; (B) tagging, by a first broadcaster of a first information-media in conjunction with the agency, a preponderance of visitors to the first information-media with a tag—wherein said tag corresponds to an agency supervised visitor-file and the respective visitor-file has at least one visitor relevant data-aspects therein; (C) recognizing, by a second broadcaster of a second information-media in conjunction with the agency, a visitor to the second information-media as having a tag—wherein said tag corresponds to the agency supervised visitor-file; (D) accepting, by the second broadcaster in conjunction with either the agency or the first broadcaster, an offsite content presentation for the recognized visitor and the content is relevant to at least one data-aspect of the respective visitor-file; and (E) presenting the offsite content to the recognized visitor.

2. The super-saturation method for information-media according to claim 1 wherein at least one of the visitor relevant data-aspects are selected from the list: visitor provided profile disclosure, word or phrase searched by the visitor as observed by the first broadcaster in conjunction with the agency, visitor provided search word, visitor provided search phrase, product or service the visitor is interested in as observed by the first broadcaster in conjunction with the agency, visitor provided product or service he is interested in, visitor provided search cluster string, visitor provided image, visitor provided image fragment, visitor provided bio-metric, characterization of content at the first information-media, and characterization of content at a second information-media where-at offsite content was presented using the super-saturation method.

3. The super-saturation method for information-media according to claim 1 wherein the agency facilitating visitor identification includes offering an offsite content presentation for a first information-media.

4. The super-saturation method for information-media according to claim 1 wherein the agency is an advertising agency.

5. The super-saturation method for information-media according to claim 1 wherein the agency is a credit bureau.

6. The super-saturation method for information-media according to claim 1 wherein the agency is a public service organization.

7. The super-saturation method for information-media according to claim 1 wherein the agency is a legally empowered body.

8. The super-saturation method for information-media according to claim 1 wherein the agency is a media service provider.

9. The super-saturation method for information-media according to claim 1 wherein the agency is a cellular telephone service provider.

10. The super-saturation method for information-media according to claim 1 wherein the agency is a wireless communication service provider.

11. The super-saturation method for information-media according to claim 3 wherein offering includes selling.

12. The super-saturation method for information-media according to claim 3 wherein offering includes renting.

13. The super-saturation method for information-media according to claim 3 wherein offering includes leasing.

14. The super-saturation method for information-media according to claim 3 wherein offering includes trading.

15. The super-saturation method for information-media according to claim 3 wherein offering includes proposing for payment.

16. The super-saturation method for information-media according to claim 1 wherein the offsite content presentation is an advertisement presentation.

17. The super-saturation method for information-media according to claim 1 wherein the offsite content presentation is a notification.

18. The super-saturation method for information-media according to claim 17 wherein the notification is a public service announcement.

19. The super-saturation method for information-media according to claim 17 wherein the notification is a personal reminder.

20. The super-saturation method for information-media according to claim 17 wherein the notification is a judicial instrument.

21. The super-saturation method for information-media according to claim 17 wherein the notification is a credit warning.

22. The super-saturation method for information-media according to claim 1 wherein the offsite content presentation is a graphic item.

23. The super-saturation method for information-media according to claim 1 wherein the offsite content presentation is multimedia.

24. The super-saturation method for information-media according to claim 1 wherein the offsite content presentation is audio.

25. The super-saturation method for information-media according to claim 1 wherein the offsite content presentation is a banner.

26. The super-saturation method for information-media according to claim 1 wherein the first information-media is Internet data communications protocol based.

27. The super-saturation method for information-media according to claim 26 wherein the Internet data communications media includes at least one content presentation of a plurality of content presentations.

28. The super-saturation method for information-media according to claim 1 wherein the first information-media is interactive data communications protocol based.

29. The super-saturation method for information-media according to claim 28 wherein interactive data communication is a telephone communication service.

30. The super-saturation method for information-media according to claim 28 wherein the interactive data communication is a wireless communication service.

31. The super-saturation method for information-media according to claim 28 wherein the interactive data communication is a cellular communication service.

32. The super-saturation method for information-media according to claim 1 wherein the first information-media is a broadcasting system.

33. The super-saturation method for information-media according to claim 1 wherein the first information-media is a hyperlink.

34. The super-saturation method for information-media according to claim 1 wherein the first information-media is a banner.

35. The super-saturation method for information-media according to claim 1 wherein the first broadcaster is associated with an interactive data communication media.

36. The super-saturation method for information-media according to claim 1 wherein the first broadcaster is a Web site of an Internet data communication server.

37. The super-saturation method for information-media according to claim 1 wherein the first broadcaster is an advertising media.

38. The super-saturation method for information-media according to claim 1 wherein the first broadcaster is a credit agency.

39. The super-saturation method for information-media according to claim 1 wherein the first broadcaster is a credit control agency for a credit card organization.

40. The super-saturation method for information-media according to claim 1 wherein the first broadcaster is a banner promotion agency.

41. The super-saturation method for information-media according to claim 1 wherein the first broadcaster is a public service organization.

42. The super-saturation method for information-media according to claim 1 wherein the first broadcaster is a legally empowered body.

43. The super-saturation method for information-media according to claim 1 wherein the first broadcaster is a media agency.

44. The super-saturation method for information-media according to claim 1 wherein the first broadcaster is a cellular telephone service provider.

45. The super-saturation method for information-media according to claim 1 wherein the first broadcaster is a wireless communication media.

46. The super-saturation method for information-media according to claim 1 wherein the first broadcaster is a hyperlink.

47. The super-saturation method for information-media according to claim 1 wherein tagging the preponderance of visitors includes placing a cookie into substantially each visitor of the preponderance of visitors.

48. The super-saturation method for information-media according to claim 47 wherein placing the cookie into substantially each visitor of the preponderance of visitors includes placing an identification message into substantially each respective visitor's web browser when the visitor requests a page.

49. The super-saturation method for information-media according to claim 1 wherein tagging the preponderance of visitors includes for substantially each visitor of the preponderance of visitors placing a notification into a telephone system database.

50. The super-saturation method for information-media according to claim 1 wherein tagging the preponderance of visitors includes for substantially each visitor of the preponderance of visitors placing a message identifier record into a database for the preponderance of visitors.

51. The super-saturation method for information-media according to claim 1 wherein tagging the preponderance of visitors includes for substantially each visitor of the preponderance of visitors placing a credit warning into a credit card database.

52. The super-saturation method for information-media according to claim 1 wherein tagging the preponderance of visitors includes for substantially each visitor of the preponderance of visitors placing a personal notice into a public service database.

53. The super-saturation method for information-media according to claim 1 wherein tagging the preponderance of visitors includes for substantially each visitor of the preponderance of visitors sending a legal instrument into a legally empowered body database.

54. The super-saturation method for information-media according to claim 1 wherein tagging the preponderance of visitors includes for substantially each visitor of the preponderance of visitors placing a message into a cellular telephone SIM card.

55. The super-saturation method for information-media according to claim 1 wherein tagging the preponderance of visitors includes for substantially each visitor of the preponderance of visitors placing a notification into a wireless communication service database.

56. The super-saturation method for information-media according to claim 1 wherein substantially each visitor of the preponderance of visitors to the first information-media is classified as a preferred visitor.

57. The super-saturation method for information-media according to claim 56 wherein the preferred visitor stays at the first information-media for at least a predetermined period of time.

58. The super-saturation method for information-media according to claim 56 wherein the preferred visitor spends at least a predetermined amount of money at the first information-media.

59. The super-saturation method for information-media according to claim 1 wherein the tag is a cookie.

60. The super-saturation method for information-media according to claim 1 wherein the tag is an identification message.

61. The super-saturation method for information-media according to claim 1 wherein the tag is a notification in a telephone system database.

62. The super-saturation method for information-media according to claim 1 wherein the tag is a message identifier record in a database.

63. The super-saturation method for information-media according to claim 1 wherein the tag is a credit warning in a credit card database.

64. The super-saturation method for information-media according to claim 1 wherein the tag is a personal notice in a public service database.

65. The super-saturation method for information-media according to claim 1 wherein the tag is a legal instrument in a legally empowered body database.

66. The super-saturation method for information-media according to claim 1 wherein the tag is a message in a cellular telephone SIM card.

67. The super-saturation method for information-media according to claim 1 wherein the tag is a notification into a wireless communication service database.

68. The super-saturation method for information-media according to claim 1 wherein the second broadcaster is associated with an interactive data communication media.

69. The super-saturation method for information-media according to claim 1 wherein the second broadcaster is a Web site on an Internet data communication media.

70. The super-saturation method for information-media according to claim 1 wherein the second broadcaster is an advertising media.

71. The super-saturation method for information-media according to claim 1 wherein the second broadcaster is a credit agency.

72. The super-saturation method for information-media according to claim 1 wherein the second broadcaster is a credit control agency for a credit card organization.

73. The super-saturation method for information-media according to claim 1 wherein the second broadcaster is a banner promotion agency.

74. The super-saturation method for information-media according to claim 1 wherein the second broadcaster is a public service organization.

75. The super-saturation method for information-media according to claim 1 wherein the second broadcaster is a legally empowered body.

76. The super-saturation method for information-media according to claim 1 wherein the second broadcaster is a media agency.

77. The super-saturation method for information-media according to claim 1 wherein the second broadcaster is a cellular telephone service provider.

78. The super-saturation method for information-media according to claim 1 wherein the second broadcaster is a wireless communication media.

79. The super-saturation method for information-media according to claim 1 wherein the second broadcaster is a hyperlink.

80. The super-saturation method for information-media according to claim 1 wherein the second information-media and the first information-media constitute a single media.

81. The super-saturation method for information-media according to claim 1 wherein the second information-media is Internet data communications protocol based.

82. The super-saturation method for information-media according to claim 81 wherein the Internet data communications media includes at least one content presentation of a plurality of content presentations.

83. The super-saturation method for information-media according to claim 1 wherein the second information-media is interactive data communications protocol based.

84. The super-saturation method for information-media according to claim 83 wherein interactive data communication is a telephone communication service.

85. The super-saturation method for information-media according to claim 83 wherein interactive data communication is a wireless communication service.

86. The super-saturation method for information-media according to claim 83 wherein interactive data communication is a cellular communication service.

87. The super-saturation method for information-media according to claim 1 wherein the second information-media is a broadcasting media.

88. The super-saturation method for information-media according to claim 1 wherein the second information-media is a hyperlink.

89. The super-saturation method for information-media according to claim 1 wherein the second information-media is a banner.

90. The super-saturation method for information-media according to claim 1 wherein recognizing the visitor to the second information-media includes accessing a cookie.

91. The super-saturation method for information-media according to claim 1 wherein recognizing the visitor to the second information-media includes receiving an identification message.

92. The super-saturation method for information-media according to claim 1 wherein recognizing the visitor to the second information-media includes querying a notification in a telephone system database.

93. The super-saturation method for information-media according to claim 1 wherein recognizing the visitor to the second information-media includes identifying a message identifier record in a database.

94. The super-saturation method for information-media according to claim 1 wherein recognizing the visitor to the second information-media includes receiving a credit warning in a credit card database.

95. The super-saturation method for information-media according to claim 1 wherein recognizing the visitor to the second information-media includes searching for a personal notice in a public service database.

96. The super-saturation method for information-media according to claim 1 wherein recognizing the visitor to the second information-media includes querying a legal instrument in a legally empowered body database.

97. The super-saturation method for information-media according to claim 1 wherein recognizing the visitor to the second information-media includes searching for a message in a cellular telephone SIM card.

98. The super-saturation method for information-media according to claim 1 wherein recognizing the visitor to the second information-media includes finding a notification into a wireless communication service database.

99. The super-saturation method for information-media according to claim 1 wherein, in conjunction with the agency, the second broadcaster accepting the offsite content presentation includes receiving an advertisement presentation.

100. The super-saturation method for information-media according to claim 1 wherein, in conjunction with the agency, the second broadcaster accepting the offsite content presentation includes receiving a public service announcement.

101. The super-saturation method for information-media according to claim 1 wherein, in conjunction with the agency, the second broadcaster accepting the offsite content presentation includes receiving a personal reminder.

102. The super-saturation method for information-media according to claim 1 wherein, in conjunction with the agency, the second broadcaster accepting the offsite content presentation includes receiving a judicial instrument.

103. The super-saturation method for information-media according to claim 1 wherein, in conjunction with the agency, the second broadcaster accepting the offsite content presentation includes receiving a credit warning.

104. The super-saturation method for information-media according to claim 1 wherein, in conjunction with the agency, the second broadcaster accepting the offsite content presentation includes receiving a graphic item.

105. The super-saturation method for information-media according to claim 1 wherein, in conjunction with the agency, the second broadcaster accepting the offsite content presentation includes receiving a multimedia presentation.

106. The super-saturation method for information-media according to claim 1 wherein, in conjunction with the agency, the second broadcaster accepting the offsite content presentation includes receiving an audio presentation.

107. The super-saturation method for information-media according to claim 1 wherein, in conjunction with the agency, the second broadcaster accepting the offsite content presentation includes receiving a banner.

108. The super-saturation method for information-media according to claim 1 wherein, in conjunction with the agency, the second broadcaster accepting the offsite content presentation for the recognized visitor includes the second broadcaster dropping the offsite content presentation into the browser of the visitor.

109. The super-saturation method for information-media according to claim 1 wherein, in conjunction with the agency, the second broadcaster accepting the offsite content presentation for the recognized visitor includes the second broadcaster sending the browser of the visitor to fetch the offsite content presentation.

110. The super-saturation method for information-media according to claim 1 wherein, in conjunction with the agency, the second broadcaster accepting the offsite content presentation for the recognized visitor includes the second broadcaster sending the offsite content presentation to the recognized visitor via the second information-media.

111. The super-saturation method for information-media according to claim 1 wherein, in conjunctionion the first broadcaster, the second broadcaster accepting the offsite content presentation includes receiving an advertisement presentation.

112. The super-saturation method for information-media according to claim 1 wherein, in conjunction with the first broadcaster, the second broadcaster accepting the offsite content presentation includes receiving a public service announcement.

113. The super-saturation method for information-media according to claim 1 wherein, in conjunction with the first broadcaster, the second broadcaster accepting the offsite content presentation includes receiving a personal reminder.

114. The super-saturation method for information-media according to claim 1 wherein, in conjunction with the first broadcaster, the second broadcaster accepting the offsite content presentation includes receiving judicial instrument.

115. The super-saturation method for information-media according to claim 1 wherein, in conjunction with the first broadcaster, the second broadcaster accepting the offsite content presentation includes receiving a credit warning.

116. The super-saturation method for information-media according to claim 1 wherein, in conjunction with the first broadcaster, the second broadcaster accepting the offsite content presentation includes a receiving graphic item.

117. The super-saturation method for information-media according to claim 1 wherein, in conjunction with the first broadcaster, the second broadcaster accepting the offsite content presentation includes receiving a multimedia presentation.

118. The super-saturation method for information-media according to claim 1 wherein, in conjunction with the first broadcaster, the second broadcaster accepting the offsite content presentation includes receiving an audio presentation.

119. The super-saturation method for information-media according to claim 1 wherein, in conjunction with the first broadcaster, the second broadcaster accepting the offsite content presentation includes receiving a banner.

120. The super-saturation method for information-media according to claim 1 wherein, in conjunction with the first broadcaster, the second broadcaster accepting the offsite content presentation for the recognized visitor includes the second broadcaster sending the offsite content presentation into a browser of the visitor.

121. The super-saturation method for information-media according to claim 1 wherein, in conjunction with the first broadcaster, the second broadcaster accepting the offsite content presentation for the recognized visitor includes the second broadcaster directing a browser of the visitor to fetch the offsite content presentation.

122. The super-saturation method for information-media according to claim 1 wherein, in conjunction with the first broadcaster, the second broadcaster accepting the offsite content presentation for the recognized visitor includes the second broadcaster sending the offsite content presentation to the recognized visitor via the second information-media.

123. A system including computer usable media having computer readable program code embodied therein for a super-saturation method for information-media, the computer readable program code comprising: (A) a first computer readable program code for causing an agency to facilitate visitor identification and visitor-file supervision; (B) a second computer readable program code for tagging, by a first broadcaster of a first information-media, in conjunction with the agency, a preponderance of visitors to the first information-media with a tag—wherein said tag corresponds to an agency supervised visitor-file and the respective visitor-file has at least one attribute; and (C) a third computer readable program code for recognizing, by a second broadcaster of a second information-media in conjunction with the agency, a visitor to the second information-media as having a tag—wherein said tag corresponds to the agency supervised visitor-file; for accepting, by the second broadcaster in conjunction with either the agency or the first broadcaster, an offsite content presentation for the recognized visitor and the content is relevant to at least one data-aspect of the respective visitor-file; and for presenting the offsite content to the recognized visitor.

124. The system including computer usable media having computer readable program code embodied therein for a super-saturation method for information-media according to claim 123 wherein at least one of the visitor relevant data-aspects are selected from the list: visitor provided profile disclosure, word or phrase searched by the visitor as observed by the first broadcaster in conjunction with the agency, visitor provided search word, visitor provided search phrase, product or service the visitor is interested in as observed by the first broadcaster in conjunction with the agency, visitor provided product or service he is interested in, visitor provided search cluster string, visitor provided image, visitor provided image fragment, visitor provided bio-metric, characterization of content at the first information-media, and characterization of content at a second information-media where-at offsite content was presented using the super-saturation method.

125. The super-saturation method for information-media according to claim 1 wherein the facilitating includes a pro-active supervisor program operating in a data-communications network environment (A) validating an identifier at a computer-communications machine in a data-communications network; (B) maintaining an attribute profile corresponding to the identifier; (C) for substantially each occurrence of the validating wherein the machine is transmitting a parameter string, incorporating at least one attribute of that string into the profile; and (D) for substantially each occurrence of the validating wherein the machine is in the process of receiving information-media content having at least one slot for elective content, consulting the profile in order to select a preferred instance of information-media for the at least one slot.

126. The super-saturation method for information-media according to claim 125 wherein the step of validating includes recognizing a cookie as the identifier.

127. The super-saturation method for information-media according to claim 125 wherein the step of validating includes recognizing a caller-ID as the identifier.

128. The super-saturation method for information-media according to claim 125 wherein the step of validating includes registering a profile detail restriction level from the computer-communications machine.

129. The super-saturation method for information-media according to claim 125 wherein the step of maintaining includes accumulating URL visitation data.

130. The super-saturation method for information-media according to claim 125 wherein the step of maintaining includes accumulating commercial transaction data.

131. The super-saturation method for information-media according to claim 125 wherein the step of maintaining includes accumulating caller activity data.

132. The super-saturation method for information-media according to claim 125 wherein the step of incorporating includes recording at least one attribute associated with the destination for the transmitting.

133. The super-saturation method for information-media according to claim 132 wherein the step of recording includes classifying into a category selected from the list: search engine, commercial query, commercial transaction, media warehouse, chat room, group-ware tool, e-learning seminar, interactive web-cast, matching engine.

134. The super-saturation method for information-media according to claim 125 wherein the step of incorporating includes clustering pointers, for use in correlating parameter strings having multiple attributes.

135. The super-saturation method for information-media according to claim 125 wherein the step of incorporating includes recording temporal data, and the temporal data is selected from the list: time, exact absolute date, approximate absolute date, exact relative sequential relation to prior recorded temporal dates in the respective profile, and approximate relative sequential relation to prior recorded temporal dates in the respective profile.

136. The super-saturation method for information-media according to claim 125 wherein the step of consulting includes preprocessing the profile at predetermined times.
